(19) United States
(12) Patent Application Publication
(10) Pub. No.: US 2025/0382456 A1
(43) Pub. Date: Dec. 18, 2025

(54) RESIN COMPOSITION, PREPREG, FILM WITH RESIN, METAL FOIL WITH RESIN, METAL-CLAD LAMINATE, AND WIRING BOARD

(71) Applicant: PANASONIC INTELLECTUAL PROPERTY MANAGEMENT CO., LTD., Osaka (JP)

(72) Inventors: Hajime OGUSHI, Fukushima (JP); Akira OTSUKA, Fukushima (JP); Hiroyuki FUJISAWA, Fukushima (JP); Taichi NAKASHIMA, Osaka (JP); Hayate HIRONO, Fukushima (JP)

(73) Assignee: PANASONIC INTELLECTUAL PROPERTY MANAGEMENT CO., LTD., Osaka (JP)

(21) Appl. No.: 18/995,492

(22) PCT Filed: Jul. 10, 2023
(86) PCT No.: PCT/JP2023/025509

§ 371 Date: Jan. 16, 2025

(30) Foreign Application Priority Data
Jul. 20, 2022 (JP) 2022-115729

(51) Int. Cl. C08L 71/12; C08J 5/24; C08K 3/36; C08K 5/3417; C08K 5/357; C08K 7/20; C08K 9/06

(52) U.S. Cl. CPC C08L 71/126; C08J 5/244; C08K 3/36; C08K 5/3417; C08K 5/357; C08K 7/20; C08K 9/06; C08J 2371/12; C08L 2203/20; C08L 2205/025

(57) ABSTRACT

A resin composition containingcontains a polyphenylene ether compound (A) having a hydroxyl group in the molecule, a polyphenylene ether compound (B) having an unsaturated double bond in the molecule, a reactive compound (C) including at least one selected from a maleimide compound (C1) or a benzoxazine compound (C2), and an inorganic filler (D), in which the content of the polyphenylene ether compound (A) is 1 part by mass or more and less than 50 parts by mass with respect to 100 parts by mass of the sum of the polyphenylene ether compound (A) and the polyphenylene ether compound (B).

### TECHNICAL FIELD

The present invention relates to a resin composition, a prepreg, a film with resin, a metal foil with resin, a metal-clad laminate, and a wiring board.

### BACKGROUND ART

In various electronic devices, mounting technologies such as higher integration of semiconductor devices to be mounted, higher wiring density, and multi-layering have rapidly progressed along with an increase in the amount of information processed. In addition, wiring boards used in various electronic devices are required to be, for example, high-frequency compatible wiring boards such as a millimeter-wave radar board for in-vehicle use. Substrate materials for forming insulating layers of wiring boards used in various electronic devices are required to have a low dielectric constant and a low dielectric loss tangent in order to increase the signal transmission speed and to decrease the signal transmission loss.

It is known that polyphenylene ether exhibits excellent low dielectric properties such as a low relative dielectric constant and a low dielectric loss tangent and exhibits excellent low dielectric properties such as a low relative dielectric constant and a low dielectric loss tangent in a high frequency band (high frequency region) from the MHz band to the GHz band as well. For this reason, it has been investigated that polyphenylene ether is used, for example, as a high frequency molding material. More specifically, polyphenylene ether is preferably used as a substrate material for forming an insulating layer of a wiring board to be equipped in electronic equipment utilizing a high frequency band.

To date, as resin compositions containing modified polyphenylene ether, for example, Patent Literature 1 discloses a polyphenylene ether resin composition containing polyphenylene ether having a polyphenylene ether moiety in the molecular structure, a p-ethenylbenzyl group, a m-ethenylbenzyl group and the like at the molecular terminals, and a number average molecular weight of 1000 to 7000, and a crosslinking type curing agent.

The polyphenylene ether resin composition described in Patent Literature 1 is said to be capable of providing a laminate exhibiting dielectric properties and heat resistance.

On the other hand, in electronic equipment, particularly small portable devices such as portable communication terminals and notebook computers, diversification, improvement in performance, thinning, and miniaturization have rapidly proceeded. Along with this, in wiring boards used in these products as well, there is a further demand for refinement of conductor wiring, multilayering of conductor wiring layers, thinning, and improvement in performance such as mechanical properties. For this reason, the requirements for various properties in the insulating layers of recent printed wiring boards and the like have further increased, and there is a demand for substrate materials that are equipped with high levels of properties such as desmear properties, adhesive properties to metal foils, and glass transition temperature as well as maintain excellent dielectric (electrical) properties.

Specifically, insulating layers of wiring boards used in various kinds of electronic equipment are desired to have a property that smears generated by the drilling can be properly removed when drilling is performed using a drill, laser, or the like. In other words, insulating layers of wiring boards preferably have a property (excellent desmear properties) that smears can be properly removed with permanganic acid or the like while damage to the insulating layers of wiring boards is suppressed. Hence, substrate materials for forming insulating layers of wiring boards are required to afford cured products exhibiting excellent desmear properties.

Wiring boards used in various kinds of electronic equipment are also required to be hardly affected by changes in the external environment. In other words, substrate materials for forming insulating layers of wiring boards are desired to afford cured products having high glass transition temperatures in order to obtain wiring boards exhibiting excellent reliability in a wide temperature range as well.

Furthermore, metal-clad laminates and metal foils with resin used in the manufacture of wiring boards and the like include not only an insulating layer but also a metal foil on the insulating layer. Wiring boards also include not only an insulating layer but also a wiring on the insulating layer. Examples of the wiring include wiring derived from a metal foil equipped in the metal-clad laminate or the like.

In the wiring boards, it is desired that the wirings do not peel off from the insulating layers although the provided wirings are refined wirings. In order to meet this requirement, in the wiring boards, the adhesive properties between wirings and insulating layers are preferably high. Hence, it is required that the adhesive properties between metal foils and insulating layers are high in metal-clad laminates, and substrate materials for forming insulating layers of wiring boards are required to afford cured products exhibiting excellent adhesive properties to metal foils.

The present invention has been made in view of such circumstances, and an object thereof is to provide a resin composition affording a cured product, which is excellent in low dielectric properties, desmear properties, and adhesive properties to a metal foil and has a high glass transition temperature. Another object of the present invention is to provide a prepreg, a film with resin, a metal foil with resin, a metal-clad laminate, and a wiring board, which are obtained using the resin composition.

### CITATION LIST

### Patent Literature

Patent Literature 1: JP 2006-516297 A

### SUMMARY OF INVENTION

The resin composition according to an aspect of the present invention contains a polyphenylene ether compound (A) having a hydroxyl group in the molecule, a polyphenylene ether compound (B) having an unsaturated double bond in the molecule, a reactive compound (C) including at least one selected from a maleimide compound (C1) or a benzoxazine compound (C2), and an inorganic filler (D), in which the content of the polyphenylene ether compound (A) is 1 part by mass or more and less than 50 parts by mass with respect to 100 parts by mass of the sum of the polyphenylene ether compound (A) and the polyphenylene ether compound (B).

### BRIEF DESCRIPTION OF DRAWINGS

FIG. 1 is a schematic sectional view illustrating an example of a prepreg according to an embodiment of the present invention.

FIG. 2 is a schematic sectional view illustrating an example of a metal-clad laminate according to an embodiment of the present invention.

FIG. 3 is a schematic sectional view illustrating an example of a wiring board according to an embodiment of the present invention.

FIG. 4 is a schematic sectional view illustrating an example of a metal foil with resin according to an embodiment of the present invention.

FIG. 5 is a schematic sectional view illustrating an example of a film with resin according to an embodiment of the present invention.

### DESCRIPTION OF EMBODIMENTS

Hereinafter, embodiments according to the present invention will be described, but the present invention is not limited thereto.

### Resin Composition

The resin composition according to an embodiment of the present invention contains a polyphenylene ether compound (A) having a hydroxyl group in the molecule, a polyphenylene ether compound (B) having an unsaturated double bond in the molecule, a reactive compound (C) including at least one selected from a maleimide compound (C1) or a benzoxazine compound (C2), and an inorganic filler (D), in which the content of the polyphenylene ether compound (A) is 1 part by mass or more and less than 50 parts by mass with respect to 100 parts by mass of the sum of the polyphenylene ether compound (A) and the polyphenylene ether compound (B). By curing the resin composition having such a configuration, a cured product is obtained which is excellent in low dielectric properties, desmear properties, and adhesive properties to a metal foil and has a high glass transition temperature.

According to the present embodiment, it is possible to provide a resin composition affording a cured product, which is excellent in low dielectric properties, desmear properties, and adhesive properties to a metal foil and has a high glass transition temperature. In addition, according to the present embodiment, it is possible to provide a prepreg, a film with resin, a metal foil with resin, a metal-clad laminate, and a wiring board, which are obtained using the resin composition.

### (Polyphenylene Ether Compound (A))

The polyphenylene ether compound (A) is not particularly limited as long as it is a polyphenylene ether compound having a hydroxyl group in the molecule. The polyphenylene ether compound having a hydroxyl group in the molecule is not particularly limited as long as it is polyphenylene ether having one or more hydroxyl groups in the molecule, but examples thereof include a polyphenylene ether compound in which hydroxyl groups at both terminals or one terminal of a polyphenylene ether compound remain without being unmodified. More specifically, the polyphenylene ether compound (A) has a polyphenylene ether chain in the molecule, and it is preferable to have, for example, a repeating unit represented by the following Formula (1) in the molecule as the polyphenylene ether compound (A).

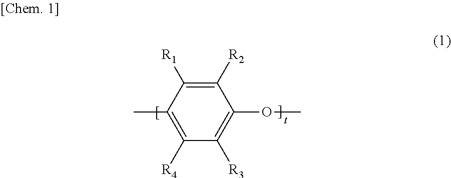

In Formula (1), t represents 1 to 50. R₁ to R₄ are independent of each other. In other words, R₁ to R₄ be the same group as or different groups from each other. R₁ to R₄ represent a hydrogen atom, an alkyl group, an alkenyl group, an alkynyl group, a formyl group, an alkylcarbonyl group, an alkenylcarbonyl group, or an alkynylcarbonyl group. Among these, a hydrogen atom and an alkyl group are preferable.

Specific examples of the respective functional groups mentioned in R₁ to R₄ the following.

The alkyl group is not particularly limited and is, for example, preferably an alkyl group having 1 to 18 carbon atoms and more preferably an alkyl group having 1 to 10 carbon atoms. Specific examples of the alkyl group include a methyl group, an ethyl group, a propyl group, a hexyl group, and a decyl group.

The alkenyl group is not particularly limited and is, for example, preferably an alkenyl group having 2 to 18 carbon atoms and more preferably an alkenyl group having 2 to 10 carbon atoms. Specific examples of the alkenyl group include a vinyl group, an allyl group, and a 3-butenyl group.

The alkynyl group is not particularly limited and is, for example, preferably an alkynyl group having 2 to 18 carbon atoms and more preferably an alkynyl group having 2 to 10 carbon atoms. Specific examples of the alkynyl group include an cthynyl group and a prop-2-yn-1-yl group (propargyl group).

The alkylcarbonyl group is not particularly limited as long as it is a carbonyl group substituted with an alkyl group and is, for example, preferably an alkylcarbonyl group having 2 to 18 carbon atoms and more preferably an alkylcarbonyl group having 2 to 10 carbon atoms. Specific examples of the alkylcarbonyl group include an acetyl group, a propionyl group, a butyryl group, an isobutyryl group, a pivaloyl group, a hexanoyl group, an octanoyl group, and a cyclohexylcarbonyl group.

The alkenylcarbonyl group is not particularly limited as long as it is a carbonyl group substituted with an alkenyl group and is, for example, preferably an alkenylcarbonyl group having 3 to 18 carbon atoms and more preferably an alkenylcarbonyl group having 3 to 10 carbon atoms. Specific examples of the alkenylcarbonyl group include an acryloyl group, a methacryloyl group, and a crotonoyl group.

The alkynylcarbonyl group is not particularly limited as long as it is a carbonyl group substituted with an alkynyl group and is, for example, preferably an alkynylcarbonyl group having 3 to 18 carbon atoms and more preferably an alkynylcarbonyl group having 3 to 10 carbon atoms. Specific examples of the alkynylcarbonyl group include a propioloyl group.

The weight average molecular weight (Mw) and number average molecular weight (Mn) of the polyphenylene ether compound (A) are not particularly limited, but for example, are preferably 500 to 5,000, preferably 800 to 4,000, preferably 1,000 to 3,000. It is considered that heat resistance of the cured product can be more reliably attained as the molecular weight is 500 or more. It is considered that sufficient fluidity can be attained and molding defects can be suppressed as the molecular weight is 5,000 or less. Hence, when the weight average molecular weight of the polyphenylene ether compound (A) is in the above range, excellent heat resistance and moldability of the cured product can be realized.

Here, the weight average molecular weight and number average molecular weight may be those measured by general molecular weight measurement methods, and specific examples thereof include values measured by gel permeation chromatography (GPC). In a case where the polyphenylene ether compound (A) has a repeating unit represented by Formula (1) in the molecule, t is preferably a numerical value so that the weight average molecular weight and number average molecular weight of the polyphenylene ether compound (A) are in the above ranges. Specifically, t in Formula (1) is preferably 1 to 50.

The average number of hydroxyl groups (number of hydroxyl groups) in the polyphenylene ether compound (A) is not particularly limited, but is, for example, preferably 1 to 5, more preferably 1.5 to 3. When the number of hydroxyl groups is too small, sufficient heat resistance of the cured product tends to be hardly attained. When the number of hydroxyl groups is too large, the reactivity becomes too high, and for example, the storage stability of the resin composition may decrease.

The number of hydroxyl groups in the polyphenylene ether compound (A) can be found, for example, from the product standard value of the polyphenylene ether compound used. Specific examples of the number of hydroxyl groups here include a numerical value representing the average value of hydroxyl groups per 1 molecule of all polyphenylene ether compounds present in 1 mole of polyphenylene ether compound.

The intrinsic viscosity of the polyphenylene ether compound (A) is not particularly limited, and is, for example, preferably 0.03 to 0.12 dl/g, more preferably 0.04 to 0.11 dl/g, still more preferably 0.06 to 0.095 dl/g. It is considered that heat resistance of the cured product can be more reliably attained as the intrinsic viscosity is 0.03 dl/g or more. It is considered that sufficient fluidity can be attained and molding defects can be suppressed as the intrinsic viscosity is 0.12 dl/g or less. Hence, when the intrinsic viscosity of the polyphenylene ether compound (A) is in the above range, excellent heat resistance and moldability of the cured product can be realized.

The intrinsic viscosity here can be found from the product standard value of the polyphenylene ether compound used. The intrinsic viscosity here is an intrinsic viscosity measured in methylene chloride at 25° C. and more specifically is, for example, a value acquired by measuring the intrinsic viscosity of a methylene chloride solution (liquid temperature: 25° C.) at 0.18 g/45 ml using a viscometer. Examples of the viscometer include AVS500 Visco System manufactured by SCHOTT Instruments GmbH.

The polyphenylene ether compound (A) is not particularly limited, and examples thereof include those containing polyphenylene ether composed of 2,6-dimethylphenol and at least either of a bifunctional phenol or a trifunctional phenol, and polyphenylene ether such as poly (2,6-dimethyl-1,4-phenylene oxide) as a main component. More specific examples of the polyphenylene ether compound (A) include a polyphenylene ether compound represented by the following Formula (2) and a polyphenylene ether compound represented by the following Formula (3).

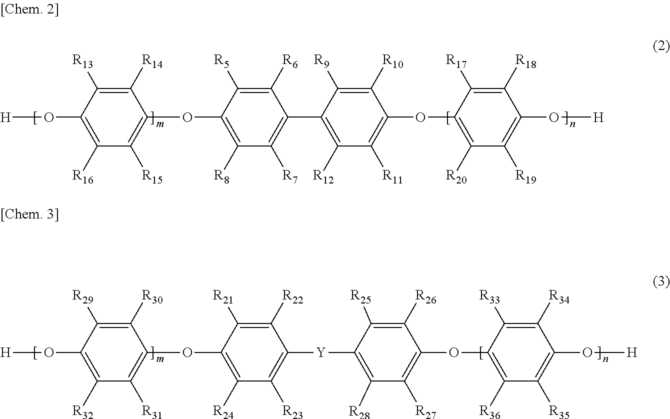

In Formulas (2) and (3), R₅ to R₂₀ and R₂₁ to R₃₆ are independent of each other. In other words, R₅ to R₂₀ and R₂₀ to R₂₆ may be the same group as or different groups from each other. Examples of R₅ to R₂₀ and R₂₁ to R₃₆ include those the same as R₁ to R₄ in Formula (1). In other words, R₅ to R₂₀ and R₂₁ to R₃₆ represent a hydrogen atom, an alkyl group, an alkenyl group, an alkynyl group, a formyl group, an alkylcarbonyl group, an alkenylcarbonyl group, or an alkynylcarbonyl group. In Formula (3), Y represents a linear, branched, or cyclic hydrocarbon having 20 or less carbon atoms. m and n each preferably represent 0 to 20. In addition, it is preferable that m and n represent numerical values so that the sum of m and n is 1 to 30. Hence, it is more preferable that m represents 0 to 20, n represents 0 to 20, and the sum of m and n represents 1 to 30.

In Formula (3), Y represents a linear, branched, or cyclic hydrocarbon having 20 or less carbon atoms as described above. Examples of Y include a group represented by the following Formula (4).

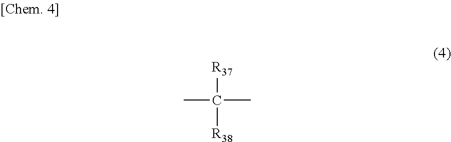

In Formula (4), R₃₇ to R₃₈ each independently represent a hydrogen atom or an alkyl group. Examples of the alkyl group include a methyl group. Examples of the group represented by Formula (4) include a methylene group, a methylmethylene group, and a dimethylmethylene group. Among these, a dimethylmethylene group is preferable.

More specific examples of the polyphenylene ether compound represented by Formula (2) include a polyphenylene ether compound represented by the following Formula (5). More specific examples of the polyphenylene ether compound represented by Formula (3) include a polyphenylene ether compound represented by the following Formula (6).

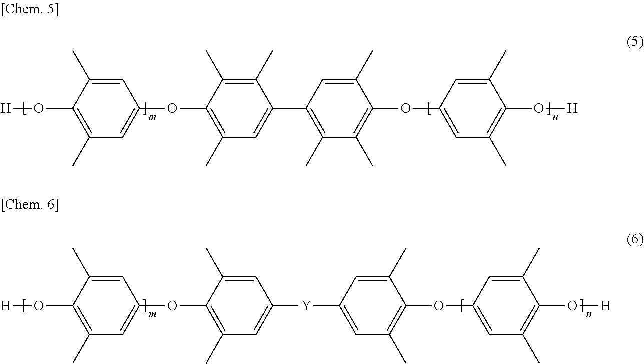

In Formulas (5) and (6), m and n are the same as m and n in Formulas (2) and (3), and specifically, m and n each preferably represent 0 to 20. In Formula (6), Y is the same as Y in Formula (3).

### (Polyphenylene Ether (B))

The polyphenylene ether (B) is not particularly limited as long as it is a polyphenylene ether compound having an unsaturated double bond in the molecule. Examples of the polyphenylenc ether compound (B) include a polyphenylene ether compound in which the terminal of the polyphenylene ether compound (A) having a repeating unit represented by Formula (1) in the molecule is modified with a substituent having a carbon-carbon unsaturated double bond.

The substituent having a carbon-carbon unsaturated double bond is not particularly limited. Examples of the substituent include a substituent represented by the following Formula (7).

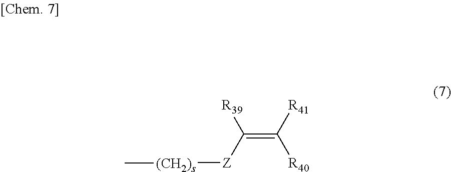

In Formula (7), s represents 0 to 10. Z represents an arylene group. R₃₉ to R₄₁ are independent of each other. In other words, R₃₉ to R₄₁ may be the same group as or different groups from each other. R₃₉ to R₄₁ represent a hydrogen atom or an alkyl group.

In a case where s in Formula (7) is 0, it indicates that Z is directly bonded to the terminal of polyphenylene ether.

The arylene group is not particularly limited, but specific examples of the arylene group include a monocyclic aromatic group such as a phenylene group, and a polycyclic aromatic group in which the aromatic is not a single ring but a polycyclic aromatic such as a naphthalene ring. This arylene group also includes a derivative in which a hydrogen atom bonded to an aromatic ring is substituted with a functional group such as an alkenyl group, an alkynyl group, a formyl group, an alkylcarbonyl group, an alkenylcarbonyl group, or an alkynylcarbonyl group.

In addition, the alkyl group is not particularly limited and is, for example, preferably an alkyl group having 1 to 18 carbon atoms and more preferably an alkyl group having 1 to 10 carbon atoms. Specific examples of the alkyl group include a methyl group, an ethyl group, a propyl group, a hexyl group, and a decyl group.

More specific examples of the substituent include vinylbenzyl groups (ethenylbenzyl groups) such as a p-ethenylbenzyl group and a m-ethenylbenzyl group, a vinylphenyl group, an acrylate group, and a methacrylate group.

Preferred specific examples of the substituent represented by Formula (7) include a functional group having a vinylbenzyl group. Specific examples thereof include at least one substituent selected from the following Formula (8) or Formula (9).

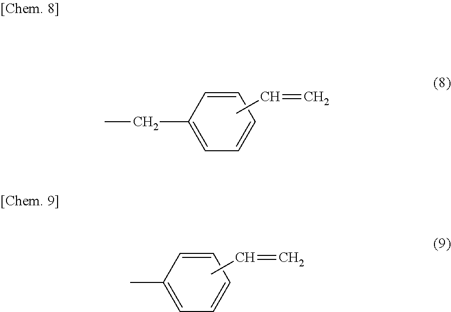

Examples of the other substituent having a carbon-carbon unsaturated double bond include a (meth) acrylate group, and for example, the substituent is represented by the following Formula (10).

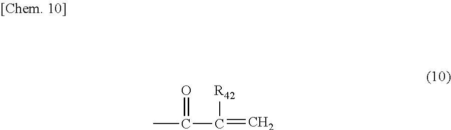

In Formula (10), R₄₂ represents a hydrogen atom or an alkyl group. The alkyl group is not particularly limited and is, for example, preferably an alkyl group having 1 to 18 carbon atoms, more preferably an alkyl group having 1 to 10 carbon atoms. Specific examples of the alkyl group include a methyl group, an ethyl group, a propyl group, a hexyl group, and a decyl group.

The weight average molecular weight (Mw) of the polyphenylene ether compound (B) is not particularly limited, but specifically, is preferably 500 to 5,000, more preferably 800 to 4,000, still more preferably 1,000 to 3,000.

Here, the weight average molecular weight may be measured by a general molecular weight measurement method, and specific examples thereof include a value measured by gel permeation chromatography (GPC). In a case where the polyphenylene ether compound (B) has a repeating unit represented by Formula (1) in the molecule, t is preferably a numerical value so that the weight average molecular weight of the modified polyphenylene ether compound is in such a range. Specifically, t in Formula (1) is preferably 1 to 50.

When the weight average molecular weight of the polyphenylene ether compound (B) is in such a range, the excellent low dielectric properties of polyphenylene ether are exhibited and a cured product exhibiting not only superior heat resistance but also excellent moldability is afforded.

The average number of the substituents (number of terminal functional groups) at the molecular terminals in the polyphenylene ether compound (B) per one molecule of the polyphenylene ether compound (B) is not particularly limited, but specifically is preferably 1 to 5, more preferably 1 to 3, still more preferably 1.5 to 3. When the number of terminal functional groups is too small, it tends to be difficult to obtain a cured product exhibiting sufficient heat resistance. When the number of terminal functional groups is too large, the reactivity is too high, and for example, there is a possibility that troubles such as a deterioration in storage stability of the resin composition and a decrease in fluidity of the resin composition may occur.

Examples of the number of terminal functional groups in the polyphenylene ether compound (B) include a numerical value expressing the average value of the substituents per one molecule of all the polyphenylene ether compounds present in one mole of the polyphenylene ether compound. This number of terminal functional groups still more specifically can be determined by, for example, calculating the decrease from the number of hydroxyl groups in the polyphenylene ether before modification to the number of hydroxyl groups remaining in the obtained polyphenylene ether compound. The number of hydroxyl groups decreased from the number of hydroxyl groups in the polyphenylene ether before being modified is the number of terminal functional groups. Moreover, with regard to the method for measuring the number of hydroxyl groups remaining in the polyphenylene ether compound, the number of hydroxyl groups can be determined by adding a quaternary ammonium salt (tetraethylammonium hydroxide) to be associated with a hydroxyl group to a solution of the polyphenylene ether compound and measuring the UV absorbance of the mixed solution.

The intrinsic viscosity of the polyphenylene ether compound (B) is not particularly limited. Specifically, the intrinsic viscosity is preferably 0.03 to 0.12 dl/g, more preferably 0.04 to 0.11 dl/g, still more preferably 0.06 to 0.095 dl/g. It is considered that heat resistance of the cured product can be more reliably attained as the intrinsic viscosity is 0.03 dl/g or more. It is considered that sufficient fluidity can be attained and molding defects can be suppressed as the intrinsic viscosity is 0.12 dl/g or less. Hence, when the intrinsic viscosity of the polyphenylene ether compound (B) is in the above range, excellent heat resistance and moldability of the cured product can be realized.

Note that the intrinsic viscosity here is an intrinsic viscosity measured in methylene chloride at 25° C. and more specifically is, for example, a value attained by measuring the intrinsic viscosity of a methylene chloride solution (liquid temperature: 25° C.) at 0.18 g/45 ml using a viscometer. Examples of the viscometer include AVS500 Visco System manufactured by SCHOTT Instruments GmbH.

As the polyphenylene ether compound (B), a commercially available product may be used, or one produced by a known synthesis method may be used. The method for synthesizing the polyphenylene ether compound (B) is not particularly limited as long as the polyphenylene ether compound (B) of which the terminal is modified with a substituent having a carbon-carbon unsaturated double bond can be synthesized. Examples of the method for synthesizing the polyphenylene ether compound (B) include a method in which the polyphenylene ether (A) is reacted with a compound in which a substituent having a carbon-carbon unsaturated double bond is bonded to a halogen atom.

Examples of the compound in which a substituent having a carbon-carbon unsaturated double bond is bonded to a halogen atom include a compound represented by the following Formula (11).

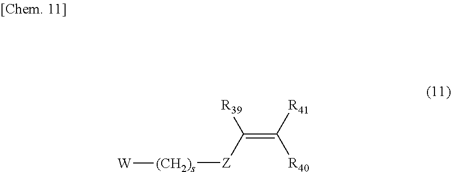

In Formula (11), s, Z, and R₃₉ to R₄₁ are the same as s, Z, and R₃₉ to R₄₁ in Formula (7). Specifically, s represents 0 to 10. Z represents an arylene group. R₃₉ to R₄₁ are independent of each other. In other words, R₃₉ to R₄₁ be the same group as or different groups from each other. R₃₉ to R₄₁ represent a hydrogen atom or an alkyl group. W represents a halogen atom, and specific examples thereof include a chlorine atom, a bromine atom, an iodine atom, and a fluorine atom. Among these, a chlorine atom is preferable.

As the compound represented by Formula (11), those exemplified above may be used singly or in combination of two or more kinds thereof.

Examples of the compound in which a substituent having a carbon-carbon unsaturated double bond is bonded to a halogen atom include p-chloromethylstyrene and m-chloromethylstyrene.

### (Reactive Compound (C))

The reactive compound (C) is not particularly limited as long as it is a reactive compound including at least one selected from a maleimide compound (C1) or a benzoxazine compound (C2). As described above, the reactive compound (C) may include only the maleimide compound (C1), or only the benzoxazine compound (C2), or both the maleimide compound (C1) and the benzoxazine compound (C2). The reactive compound (C) preferably includes both the maleimide compound (C1) and the benzoxazine compound (C2). This makes it possible to more reliably obtain a resin composition affording a cured product, which is excellent in heat resistance and adhesive properties to a metal foil.
(Maleimide Compound (C1)

The maleimide compound (C1) is not particularly limited as long as it is a compound having a maleimide group in the molecule. Examples of the maleimide compound (C1) include a monofunctional maleimide compound having one maleimide group in the molecule, a polyfunctional maleimide compound having two or more maleimide groups in the molecule, and a modified maleimide compound.

Examples of the modified maleimide compound include a modified maleimide compound in which a part of the molecule is modified with an amine compound, a modified maleimide compound in which a part of the molecule is modified with a silicone compound, and a modified maleimide compound in which a part of the molecule is modified with an amine compound and a silicone compound.

The reactive compound (C) preferably includes at least one selected from the group consisting of a maleimide compound having a biphenylaralkyl structure, a maleimide compound having a phenylmaleimide group, a maleimide compound having an alkyl group having 6 or more carbon atoms, a maleimide compound having an alkylene group having 6 or more carbon atoms, and a maleimide compound having an alkyl group having 6 or more carbon atoms and an alkylene group having 6 or more carbon atoms, as the maleimide compound (C1). This makes it possible to more reliably obtain a resin composition affording a cured product, which has an excellent relative dielectric constant and a high glass transition temperature.

Examples of the maleimide compound having a biphenylaralkyl structure include, but are not limited to, a biphenylaralkyl-type bismaleimide compound.

Examples of the maleimide compound having a phenylmaleimide group include a maleimide compound having an arylene structure bonded in the meta-orientation, 4,4′-diphenylmethanebismaleimide, polyphenylmethanemaleimide, bisphenol A diphenyl ether bismaleimide, and 3,3′-dimethyl-5,5′-diethyl-4,4′-diphenylmethanebismaleimide. Examples of the maleimide compound having an arylene structure bonded in the meta-orientation include m-phenylenebismaleimide and 4-methyl-1,3-phenylenebismaleimide.

Examples of the maleimide compound having an alkyl group having 6 or more carbon atoms, the maleimide compound having an alkylene group having 6 or more carbon atoms, and the maleimide compound having an alkyl group having 6 or more carbon atoms and an alkylene group having 6 or more carbon atoms include, but are not limited to, long-chain alkyl bismaleimides.

The reactive compound (C) more preferably contains a maleimide compound (C1-1) including at least one selected from the group consisting of a maleimide compound having a biphenylaralkyl structure and a polyphenylmethanemaleimide as the maleimide compound (C1). This makes it possible to more reliably obtain a resin composition affording a cured product, which is excellent in adhesive properties to a metal foil and has a high glass transition temperature.

The reactive compound (C) still more preferably includes the maleimide compound (C1-1) and a maleimide compound (C1-2) other than the maleimide compound (C1-1) as the malcimide compound (C1). This makes it possible to more reliably obtain a resin composition affording a cured product, which is excellent in relative dielectric constant and adhesive properties to a metal foil and has a high glass transition temperature. It is considered that in the cured product of the obtained resin composition, the effect of enhancing the uniformity of the contained components can be exhibited. As the maleimide compound (C1-2), for example, 3,3′-dimethyl-5,5′-diethyl-4,4′-diphenylmethanebismaleimide, a long-chain alkyl bismaleimide, and the like are preferable.

The maleimide compound (C1) as described above may be used singly or in combination of two or more kinds thereof.

A commercially available product can be used as the maleimide compound (C1). Specifically, for example, BMI-1000 (4,4′-diphenylmethanebismaleimide) manufactured by Daiwa Kasei Industry Co., Ltd., BMI-2300 (polyphenylmethanemaleimide) manufactured by Daiwa Kasei Industry Co., Ltd., BMI-3000 (m-phenylenebismaleimide) manufactured by Daiwa Kasei Industry Co., Ltd., BMI-4000 (bisphenol A diphenyl ether bismaleimide) manufactured by Daiwa Kasei Industry Co., Ltd., BMI-5100 (3,3′-dimethyl-5,5′-diethyl-4,4′-diphenylmethanebismaleimide) manufactured by Daiwa Kasei Industry Co., Ltd., BMI-7000 (4-methyl-1,3-phenylenebismaleimide) manufactured by Daiwa Kasei Industry Co., Ltd., MIR-3000-70T (biphenylaralkyl-type maleimide compound) manufactured by Nippon Kayaku Co., Ltd., BMI-TMH (1,6′-bismaleimide-(2,2,4-trimethyl) hexane) manufactured by Daiwa Kasei Industry Co., Ltd., and the like can be used. As the long-chain alkyl bismaleimide, BMI-1700 , BMI-1500, and BMI-689 manufactured by Designer Molercules Inc., and the like can be used.
Benzoxazine Compound (C2)

The benzoxazine compound (C2) is a compound having a benzoxazine ring in the molecule, and examples thereof include a benzoxazine resin. Examples of the benzoxazine compound (C2) include a benzoxazine compound having a phenolphthalein structure in the molecule (phenolphthalein-type benzoxazine compound), a benzoxazine compound having an alkenyl group in the molecule, a bisphenol F-type benzoxazine compound, and a diaminodiphenylmethane (DDM)-type benzoxazine compound. More specific examples of the benzoxazine compound (C2) include 3,3′-(methylene-1,4-diphenylene) bis (3,4-dihydro-2H-1,3-benzoxazine) (P-d type benzoxazine compound) and a 2,2-bis (3,4-dihydro-2H-3-phenyl-1,3-benzoxazine) methane (F-a type benzoxazine compound). The benzoxazine compound (C2) may be used singly or in combination of two or more kinds thereof.

Among the benzoxazine compounds (C2), it is preferable to use a benzoxazine compound (C2-1) having an alkenyl group in the molecule. As the benzoxazine compound (C2-1) having an alkenyl group is used, it is possible to more reliably obtain a resin composition affording a cured product, which is superior in adhesive properties to a metal foil and has a higher glass transition temperature.

The alkenyl group is not particularly limited, but examples thereof include alkenyl groups having 2 to 6 carbon atoms. Specific examples of the alkenyl group include a vinyl group, an allyl group, and a butenyl group, and among these, an allyl group is preferable.

Examples of the benzoxazine compound (C2-1) having an alkenyl group include compounds having a benzoxazine group having an alkenyl group in the molecule. Examples of the benzoxazine group (benzoxazine group having an alkenyl group) include a benzoxazine group represented by the following Formula (12) and a benzoxazine group represented by the following Formula (13). Examples of the benzoxazine compound having an alkenyl group in the molecule include a benzoxazine compound having a benzoxazine group represented by the following Formula (12) in the molecule, a benzoxazine compound having a benzoxazine group represented by the following Formula (13) in the molecule, and a benzoxazine compound having a benzoxazine group represented by the following Formula (12) and a benzoxazine group represented by the following Formula (13) in the molecule. Examples of the benzoxazine compound having a benzoxazine group represented by the following Formula (12) in the molecule include a benzoxazine compound represented by the following Formula (14).

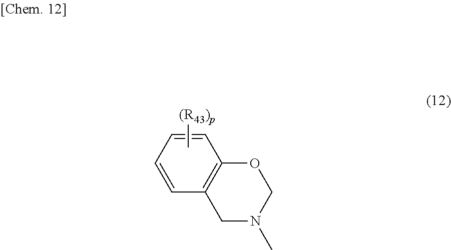

In Formula (12), R₄₃ represents an alkenyl group, and p represents the average value of the degree of substitution of R₄₃ and is 1 to 4, preferably 1.

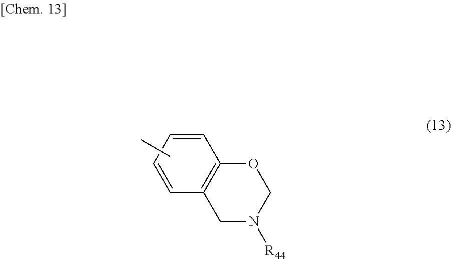

In Formula (13), R₄₄ represents an alkenyl group.

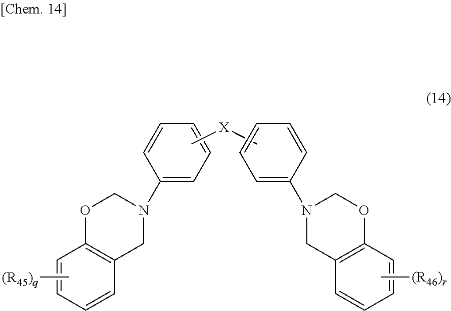

In Formula (14), R₄₅ and R₄₆ each independently represent an alkenyl group, X represents an alkylene group, and q and r cach independently represent 1 to 4.

As described above, the alkenyl group in Formulas (12) to (14) is not particularly limited, but is preferably an allyl group.

The alkylene group is not particularly limited, and examples thereof include a methylene group, an ethylene group, a propylene group, a butylene group, a pentylene group, a hexylene group, a heptylene group, an octane group, an icosane group, and a hexatriacontane group. Among these, a methylene group is preferable as the alkylene group.

In Formula (14), q is the average value of the degree of substitution of R₄₅ and is 1 to 4, preferably 1. In Formula (14), r is the average value of the degree of substitution of R₄₆ and is 1 to 4, preferably 1.

A commercially available product can be used as the benzoxazine compound (C2). For example, as the benzoxazine compound having an alkenyl group, ALP-d type benzoxazine compound manufactured by SHIKOKU CHEMICALS CORPORATION, and the like can be used. As 3,3′-(methylene-1,4-diphenylene) bis (3,4-dihydro-2H-1,3-benzoxazine), P-d type benzoxazine compound manufactured by SHIKOKU CHEMICALS CORPORATION, and the like can be used.
Another Reactive Compound

Furthermore, the reactive compound (C) may include another reactive compound (C3) in addition to at least one selected from the maleimide compound (C1) or the benzoxazine compound (C2). Examples of the other reactive compound (C3) include an allyl compound, an acrylate compound, a methacrylate compound, vinyl compounds such as a polybutadiene compound and a styrene compound, an acenaphthylene compound, a cyanate ester compound, an epoxy compound, and an active ester compound.

The allyl compound is a compound having an allyl group in the molecule, and examples thereof include a triallyl isocyanurate compound such as triallyl isocyanurate (TAIC), a diallyl bisphenol compound, and diallyl phthalate (DAP).

The acrylate compound is a compound having an acryloyl group in the molecule, and examples thereof include a monofunctional acrylate compound having one acryloyl group in the molecule and a polyfunctional acrylate compound having two or more acryloyl groups in the molecule. Examples of the monofunctional acrylate compound include methyl acrylate, ethyl acrylate, propyl acrylate, and butyl acrylate. Examples of the polyfunctional acrylate compound include diacrylate compounds such as tricyclodecanedimethanol diacrylate.

The methacrylate compound is a compound having a methacryloyl group in the molecule, and examples thereof include a monofunctional methacrylate compound having one methacryloyl group in the molecule and a polyfunctional methacrylate compound having two or more methacryloyl groups in the molecule. Examples of the monofunctional methacrylate compound include methyl methacrylate, ethyl methacrylate, propyl methacrylate, and butyl methacrylate. Examples of the polyfunctional methacrylate compound include dimethacrylate compounds such as tricyclodecanedimethanol dimethacrylate (DCP).

The vinyl compound is a compound having a vinyl group in the molecule. Examples of the vinyl compound include a monofunctional vinyl compound (monovinyl compound) having one vinyl group in the molecule and a polyfunctional vinyl compound having two or more vinyl groups in the molecule. Examples of the monofunctional vinyl compound include a styrene compound. Examples of the polyfunctional vinyl compound include a polyfunctional aromatic vinyl compound and a vinyl hydrocarbon-based compound. Examples of the vinyl hydrocarbon-based compound include divinylbenzene and a polybutadiene compound.

The acenaphthylene compound is a compound having an acenaphthylene structure in the molecule. Examples of the acenaphthylene compound include acenaphthylene, alkylacenaphthylenes, halogenated acenaphthylenes, and phenylacenaphthylenes. Examples of the alkyl acenaphthylenes include 1-methyl acenaphthylene, 3-methyl acenaphthylene, 4-methyl acenaphthylene, 5-methyl acenaphthylene, 1-ethyl acenaphthylene, 3-ethyl acenaphthylene, 4-ethyl acenaphthylene, and 5-ethyl acenaphthylene. Examples of the halogenated acenaphthylenes include 1-chloroacenaphthylene, 3-chloroacenaphthylene, 4-chloroacenaphthylene, 5-chloroacenaphthylene, 1-bromoacenaphthylene, 3-bromoacenaphthylene, 4-bromoacenaphthylene, and 5-bromoacenaphthylene. Examples of the phenylacenaphthylenes include 1-phenylacenaphthylene, 3-phenylacenaphthylene, 4-phenylacenaphthylene, and 5-phenylacenaphthylene. The acenaphthylene compound may be a monofunctional acenaphthylene compound having one acenaphthylene structure in the molecule as described above or may be a polyfunctional acenaphthylene compound having two or more acenaphthylene structures in the molecule.

The cyanate ester compound is a compound having a cyanato group in the molecule, and examples thereof include 2,2-bis (4-cyanatophenyl) propane, bis (3,5-dimethyl-4-cyanatophenyl) methane, and 2,2-bis (4-cyanatophenyl) ethane.

The epoxy compound is a compound having an epoxy group in the molecule, and examples thereof include an epoxy compound having a naphthalene skeleton and an epoxy compound having a dicyclopentadiene skeleton.

The active ester compound is a compound having an ester group exhibiting high reaction activity in the molecule, and examples thereof include a benzenecarboxylic acid active ester, a benzenedicarboxylic acid active ester, a benzenetricarboxylic acid active ester, a benzenetetracarboxylic acid active ester, a naphthalenecarboxylic acid active ester, a naphthalenedicarboxylic acid active ester, a naphthalenetricarboxylic acid active ester, a naphthalenetetracarboxylic acid active ester, a fluorenecarboxylic acid active ester, a fluorenedicarboxylic acid active ester, a fluorenetricarboxylic acid active ester, and a fluorenetetracarboxylic acid active ester.

In a case where the reactive compound (C) includes the other reactive compound (C3) other than the maleimide compound (C1) and the benzoxazine compound (C2), the reactive compound (C3) as described above may be used singly or in combination of two or more kinds thereof.

### (Inorganic Filler (D))

The inorganic filler (D) is not particularly limited as long as it is an inorganic filler that can be used as an inorganic filler contained in a resin composition. Examples of the inorganic filler (D) include metal oxides such as silica, alumina, titanium oxide, magnesium oxide and mica, metal hydroxides such as magnesium hydroxide and aluminum hydroxide, talc, aluminum borate, barium sulfate, aluminum nitride, boron nitride, barium titanate, magnesium carbonate such as anhydrous magnesium carbonate, and calcium carbonate. Among them, silica, metal hydroxides such as magnesium hydroxide and aluminum hydroxide, aluminum oxide, boron nitride, and barium titanate are preferable, and silica is more preferable. The silica is not particularly limited, and examples thereof include crushed silica, spherical silica, and silica particles.

The inorganic filler (D) may be an inorganic filler subjected to a surface treatment or an inorganic filler not subjected to a surface treatment. Examples of the surface treatment include treatment with a silane coupling agent.

Examples of the silane coupling agent include a silane coupling agent having at least one functional group selected from the group consisting of a vinyl group, a styryl group, a methacryloyl group, an acryloyl group, a phenylamino group, an isocyanurate group, a ureido group, a mercapto group, an isocyanate group, an epoxy group, and an acid anhydride group. In other words, examples of this silane coupling agent include compounds having at least one of a vinyl group, a styryl group, a methacryloyl group, an acryloyl group, a phenylamino group, an isocyanurate group, a ureido group, a mercapto group, an isocyanate group, an epoxy group, or an acid anhydride group as a reactive functional group, and further a hydrolyzable group such as a methoxy group or an ethoxy group.

Examples of the silane coupling agent include vinyltriethoxysilane and vinyltrimethoxysilane as those having a vinyl group. Examples of the silane coupling agent include p-styryltrimethoxysilane and p-styryltriethoxysilane as those having a styryl group. Examples of the silane coupling agent include 3-methacryloxypropyltrimethoxysilane, 3-methacryloxypropylmethyldimethoxysilane, 3-methacryloxypropyltriethoxysilane, 3-methacryloxypropylmethyldiethoxysilane, and 3-methacryloxypropylethyldiethoxysilane as those having a methacryloyl group. Examples of the silane coupling agent include 3-acryloxypropyltrimethoxysilane and 3-acryloxypropyltriethoxysilane as those having an acryloyl group. Examples of the silane coupling agent include N-phenyl-3-aminopropyltrimethoxysilane and N-phenyl-3-aminopropyltriethoxysilane as those having a phenylamino group.

The average particle size of the inorganic filler (D) is not particularly limited, and is preferably 0.05 to 10 μm, more preferably 0.1 to 8 μm. Here, the average particle size refers to the volume average particle size. The volume average particle size can be measured by, for example, a laser diffraction method and the like.

### (Content)

The content of the polyphenylene ether compound (A) is 1 part by mass or more and less than 50 parts by mass with respect to 100 parts by mass of the sum of the polyphenylene ether compound (A) and the polyphenylene ether compound (B). When the polyphenylene ether compound (A) is 1 part by mass or more, there is an advantage that a resin composition can be provided which affords a cured product excellent in desmear properties. When the polyphenylene ether compound (A) is less than 50 parts by mass, there is an advantage that a resin composition can be provided which affords a cured product excellent in adhesive properties to a metal foil and desmear properties.

The content of the polyphenylene ether compound (A) is preferably 3 to 45 parts by mass with respect to 100 parts by mass of the sum of the polyphenylene ether compound (A) and the polyphenylene ether compound (B).

The content of the polyphenylene ether compound (A) is preferably 0.1 to 45 parts by mass with respect to 100 parts by mass of the sum of the polyphenylene ether compound (A), the polyphenylene ether compound (B), and the reactive compound (C). As the polyphenylene ether compound (A) is 0.1 parts by mass or more, it is possible to more reliably obtain a resin composition affording a cured product excellent in desmear properties. As the polyphenylene ether compound (A) is 45 parts by mass or less, it is possible to more reliably obtain a resin composition affording a cured product excellent in adhesive properties to a metal foil and desmear properties.

The lower limit of the content of the polyphenylene ether compound (A) is more preferably 3 parts by mass or more, still more preferably 5 parts by mass or more with respect to 100 parts by mass of the sum of the polyphenylene ether compound (A), the polyphenylene ether compound (B), and the reactive compound (C). The upper limit of the content of the polyphenylene ether compound (A) is preferably 40 parts by mass or less, more preferably 30parts by mass or less.

The content of the polyphenylene ether compound (B) is preferably 10 to 70 parts by mass with respect to 100 parts by mass of the sum of the polyphenylene ether compound (A), the polyphenylene ether compound (B), and the reactive compound (C). As the polyphenylene ether compound (B) is 10 parts by mass or more, it is possible to more reliably obtain a resin composition affording a cured product excellent in adhesive properties to a metal foil and relative dielectric constant. As the polyphenylene ether compound (B) is 70 parts by mass or less, it is possible to more reliably obtain a resin composition affording a cured product excellent in desmear properties.

The lower limit of the content of the polyphenylene ether compound (B) is more preferably 15 parts by mass or more, still more preferably 20 parts by mass or more with respect to 100 parts by mass of the sum of the polyphenylene ether compound (A), the polyphenylene ether compound (B), and the reactive compound (C). The upper limit of the content of the polyphenylene ether compound (B) is more preferably 65 parts by mass or less, still more preferably 60 parts by mass or less.

Furthermore, the content of the reactive compound (C) is not particularly limited, but is preferably 10 to 80 parts by mass with respect to 100 parts by mass of the sum of the polyphenylene ether compound (A), the polyphenylene ether compound (B), and the reactive compound (C). As the content of the reactive compound (C) is 10 parts by mass or more, it is possible to more reliably obtain a resin composition affording a cured product having a high glass transition temperature. As the content of the reactive compound (C) is 80 parts by mass or less, it is possible to more reliably obtain a resin composition affording a cured product excellent in relative dielectric constant.

The lower limit of the content of the reactive compound (C) is more preferably 15 parts by mass or more, still more preferably 20 parts by mass or more with respect to 100 parts by mass of the sum of the polyphenylene ether compound (A), the polyphenylene ether compound (B), and the reactive compound (C). The upper limit of the content of the reactive compound (C) is more preferably 75 parts by mass or less, still more preferably 70 parts by mass or less.

In a case where the reactive compound (C) includes the maleimide compound (C1), the content of the maleimide compound (C1) is preferably 10 to 70 parts by mass with respect to 100parts by mass of the sum of the polyphenylene ether compound (A), the polyphenylene ether compound (B), and the reactive compound (C). When the content is set to the above range, there is an advantage that a resin composition can be more reliably obtained which affords a cured product having a high glass transition temperature.

The lower limit of the content of the maleimide compound (C1) is more preferably 15 parts by mass or more, still more preferably 20 parts by mass or more with respect to 100 parts by mass of the sum of the polyphenylene ether compound (A), the polyphenylene ether compound (B), and the reactive compound (C). The upper limit of the content of the maleimide compound (C1) is more preferably 65 parts by mass or less, still more preferably 60 parts by mass or less.

In a case where the reactive compound (C) includes the benzoxazine compound (C2), the content of the benzoxazine compound (C2) is preferably 1 to 70 parts by mass or more with respect to 100 parts by mass of the sum of the polyphenylene ether compound (A), the polyphenylene ether compound (B), and the reactive compound (C). When the content is set to the above range, there is an advantage that a resin composition can be obtained which affords a cured product having a higher glass transition temperature.

The lower limit of the content of the benzoxazine compound (C2) is more preferably 3 parts by mass or more, still more preferably 5 parts by mass or more with respect to 100 parts by mass of the sum of the polyphenylene ether compound (A), the polyphenylene ether compound (B), and the reactive compound (C).

As the upper limit of the content of the benzoxazine compound (C2), in a case where the reactive compound (C) does not include the maleimide compound (C1) but includes the benzoxazine compound (C2), the content of the benzoxazine compound (C2) is more preferably 60 parts by mass or less, still more preferably 50 parts by mass or less with respect to 100 parts by mass of the sum of the polyphenylene ether compound (A), the polyphenylene ether compound (B), and the reactive compound (C). In a case where the reactive compound (C) includes both the maleimide compound (C1) and the benzoxazine compound (C2), the content of the benzoxazine compound (C2) is more preferably 50 parts by mass or less, still more preferably 40 parts by mass or less, most preferably 20 parts by mass or less with respect to 100 parts by mass of the sum of the polyphenylene ether compound (A), the polyphenylene ether compound (B), and the reactive compound (C).

Furthermore, in a case where the reactive compound (C) contains the maleimide compound (C1-1) including at least one selected from the group consisting of a maleimide compound having a biphenylaralkyl structure and polyphenylmethanemaleimide; and the maleimide compound (C1-2) other than the maleimide compound (C1-1), the content of the maleimide compound (C1-1) is preferably 10 to 90 parts by mass, more preferably 10 to 80 parts by mass, still more preferably 25 to 60 parts by mass with respect to 100 parts by mass of the maleimide compound (C1) (with respect to 100 parts by mass of the sum of the maleimide compound (C1-1) and the maleimide compound (C1-2)). As the content of the maleimide compound (C1-1) is 10 to 90 parts by mass with respect to 100 parts by mass of the sum of the maleimide compounds (C1), it is possible to more reliably obtain a resin composition affording a cured product, which is excellent in relative dielectric constant and adhesive properties to a metal foil and has a high glass transition temperature. It is considered that in the cured product of the obtained resin composition, the effect of enhancing the uniformity of the contained components can be exhibited.

In a case where the reactive compound (C) includes the other reactive compound (C3) in addition to at least one selected from the maleimide compound (C1) or the benzoxazine compound (C2), the content of the other reactive compound (C3) is preferably 1 to 40 parts by mass, more preferably 1 to 20 parts by mass with respect to 100 parts by mass of the mass of the reactive compound (C).

The content of the inorganic filler (D) is not particularly limited, but is preferably 10 to 250 parts by mass with respect to 100 parts by mass of the sum of the polyphenylene ether compound (A), the polyphenylene ether compound (B), and the reactive compound (C). When the content of the inorganic filler (D) is 10 parts by mass or more, there is an advantage that a resin composition can be obtained which affords a cured product superior in dimensional stability. When the content of the inorganic filler is 250 parts by mass or less, there is an advantage that a resin composition can be obtained which affords a cured product superior in moldability.

The lower limit of the content of the inorganic filler (D) is more preferably 40 parts by mass or more, still more preferably 60 parts by mass or more with respect to 100 parts by mass of the sum of the polyphenylene ether compound (A), the polyphenylene ether compound (B), and the reactive compound (C). The upper limit of the content of the inorganic filler (D) is more preferably 200 parts by mass or less, still more preferably 180 parts by mass or less.

### (Other Components)

The resin composition according to the present embodiment may contain components (other components) other than the polyphenylene ether compound (A), the polyphenylene ether compound (B), the reactive compound (C), and the inorganic filler (D), if necessary, as long as the effects of the present invention are not impaired. As the other components contained in the resin composition according to the present embodiment, for example, additives such as a reaction initiator, a curing accelerator, a catalyst, a polymerization retarder, a polymerization inhibitor, a dispersant, a leveling agent, a silane coupling agent, an antifoaming agent, an antioxidant, a heat stabilizer, an antistatic agent, an ultraviolet absorber, a dye or a pigment, and a lubricant may be further contained in addition to an inorganic filler as described above.

As described above, the resin composition according to the present embodiment may contain a reaction initiator. The curing reaction can proceed even though the resin composition does not contain a reaction initiator. However, a reaction initiator may be added since there is a case where it is difficult to raise the temperature until curing proceeds depending on the process conditions. The reaction initiator is not particularly limited as long as it can promote the curing reaction of the resin composition, and examples thereof include a peroxide and an organic azo compound. Examples of the peroxide include dicumyl peroxide, α,α′-bis(t-butylperoxy-m-isopropyl) benzene, 2,5-dimethyl-2,5-di (t-butylperoxy)-3-hexyne, and benzoyl peroxide. Examples of the organic azo compound include azobisisobutyronitrile. A metal carboxylate can be concurrently used if necessary. By doing so, the curing reaction can be further promoted. Among these, α,α′-bis (t-butylperoxy-m-isopropyl) benzene is preferably used. α,α′-Bis (t-butylperoxy-m-isopropyl) benzene has a relatively high reaction initiation temperature and thus can suppress the promotion of the curing reaction at the time point at which curing is not required, for example, at the time of prepreg drying, and can suppress a decrease in storage stability of the resin composition. α,α′-Bis (t-butylperoxy-m-isopropyl) benzene exhibits low volatility, thus does not volatilize at the time of prepreg drying and storage, and exhibits favorable stability. The reaction initiators may be used singly or in combination of two or more kinds thereof.

As described above, the resin composition according to the present embodiment may contain a curing accelerator. The curing accelerator is not particularly limited as long as it can promote the curing reaction of the resin composition. Specific examples of the curing accelerator include imidazoles and derivatives thereof, organophosphorus compounds, amines such as secondary amines and tertiary amines, quaternary ammonium salts, organoboron compounds, and metal soaps. Examples of the imidazoles include 2-ethyl-4-methylimidazole, 2-methylimidazole, 2-phenyl-4-methylimidazole, 2-phenylimidazole, and 1-benzyl-2-methylimidazole. Examples of the organophosphorus compounds include triphenylphosphine, diphenylphosphine, phenylphosphine, tributylphosphine, and trimethylphosphine. Examples of the amines include dimethylbenzylamine, triethylenediamine, triethanolamine, and 1,8-diaza-bicyclo (5,4,0) undecene-7 (DBU). Examples of the quaternary ammonium salts include tetrabutylammonium bromide. Examples of the organoboron compounds include tetraphenylboron salts such as 2-ethyl-4-methylimidazole-tetraphenylborate and tetra-substituted phosphonium/tetra-substituted borate such as tetraphenylphosphonium/ethyltriphenylborate. The metal soap refers to a fatty acid metal salt, and may be a linear fatty acid metal salt or a cyclic fatty acid metal salt. Specific examples of the metal soaps include linear aliphatic metal salts and cyclic aliphatic metal salts having 6 to 10 carbon atoms. More specific examples thereof include aliphatic metal salts formed from linear fatty acids such as stearic acid, lauric acid, ricinoleic acid, and octylic acid and cyclic fatty acids such as naphthenic acid and metals such as lithium, magnesium, calcium, barium, copper, and zinc. Examples thereof include zinc octylate. The curing accelerators may be used singly or in combination of two or more kinds thereof.

As described above, the resin composition according to the present embodiment may contain a silane coupling agent. With regard to the silane coupling agent, the silane coupling agent may be contained in the resin composition as it is or may be contained as a silane coupling agent used in the surface treatment of the inorganic filler in advance. Among these, it is preferable that the silane coupling agent is contained as a silane coupling agent used in the surface treatment of the inorganic filler in advance. It is more preferable that the silane coupling agent is contained as a silane coupling agent used in the surface treatment of the inorganic filler in advance, and further contained in the resin composition as it is. In the case of a prepreg, the silane coupling agent may be contained in the prepreg as a silane coupling agent used in the surface treatment of the fibrous base material in advance. Examples of the silane coupling agent include those similar to the silane coupling agents used in the surface treatment of the inorganic filler described above.

As described above, the resin composition according to the present embodiment may contain a flame retardant. The flame retardancy of a cured product of the resin composition can be enhanced by containing a flame retardant. The flame retardant is not particularly limited. Specifically, in the field in which halogen-based flame retardants such as bromine-based flame retardants are used, for example, ethylenedipentabromobenzene, ethylenebistetrabromoimide, decabromodiphenyloxide, and tetradecabromodiphenoxybenzene that have a melting point of 300° C. or more, and a bromostyrene-based compound that reacts with the polymerizable compound are preferable. It is considered that the elimination of halogen at a high temperature and the decrease in heat resistance can be suppressed by the use of a halogen-based flame retardant. There is a case where a flame retardant containing phosphorus (phosphorus-based flame retardant) is used in fields required to be halogen-free. The phosphorus-based flame retardant is not particularly limited, and examples thereof include a phosphate ester-based flame retardant, a phosphazene-based flame retardant, a bis(diphenylphosphine oxide)-based flame retardant, and a phosphinate-based flame retardant. Specific examples of the phosphate ester-based flame retardant include a condensed phosphate ester such as dixylenyl phosphate. Specific examples of the phosphazene-based flame retardant include phenoxyphosphazene. Specific examples of the bis (diphenylphosphine oxide)-based flame retardant include xylylenebis (diphenylphosphine oxide). Specific examples of the phosphinate-based flame retardant include metal phosphinates such as an aluminum dialkyl phosphinate. As the flame retardant, the respective flame retardants exemplified may be used singly or in combination of two or more kinds thereof.

### (Use)

The resin composition is used when a prepreg is manufactured, as described later. The resin composition is used when a resin layer included in a metal foil with resin and a film with resin is formed and when an insulating layer included in a metal-clad laminate and a wiring board is formed. As described above, the resin composition affords a cured product exhibiting excellent low dielectric properties such as a low relative dielectric constant. For this reason, the resin composition is suitably used to form an insulating layer included in a wiring board compatible with high frequencies, such as wiring boards for antennas and antenna boards for millimeter-wave radar. In other words, the resin composition is suitable for manufacture of wiring boards compatible with high frequencies.

### (Production Method)

The method for producing the resin composition is not particularly limited, and examples thereof include a method in which the polyphenylene ether compound (A), the polyphenylene ether compound (B), the reactive compound (C), and the inorganic filler (D) are mixed together so as to have predetermined contents. Examples thereof include the method to be described later in the case of obtaining a varnish-like composition containing an organic solvent.

Next, a prepreg, a metal-clad laminate, a wiring board, a metal foil with resin, and a film with resin, which are obtained using the resin composition according to the present embodiment, will be described with reference to the drawings. The respective symbols in each drawing indicate the following, 1: prepreg, 2: resin composition or semi-cured product of resin composition, 3: fibrous base material, 11: metal-clad laminate, 12: insulating layer, 13: metal foil, 14: wiring, 21: wiring board, 31: metal board with resin, 32 and 42: resin layer, 41: film with resin, and 43: support film.

### Prepreg

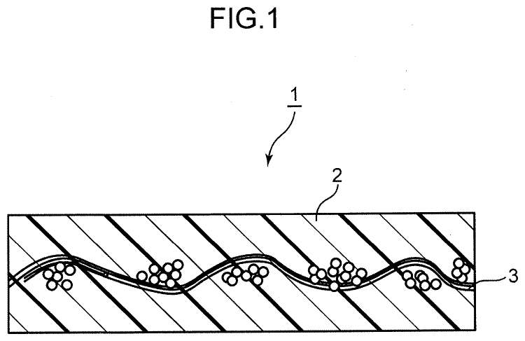

FIG. 1 is a schematic sectional view illustrating an example of a prepreg 1 according to an embodiment of the present invention.

As illustrated in FIG. 1, the prepreg 1 according to the present embodiment includes the resin composition or a semi-cured product of the resin composition 2 and a fibrous base material 3. This prepreg 1 includes the resin composition or the semi-cured product of the resin composition 2 and the fibrous base material 3 present in the resin composition or the semi-cured product of the resin composition 2.

In the present embodiment, the semi-cured product is in a state in which the resin composition has been cured to an extent that the resin composition can be further cured. In other words, the semi-cured product is the resin composition in a semi-cured state (B-staged). For example, when a resin composition is heated, the viscosity of the resin composition first gradually decreases, then curing starts, and the viscosity gradually increases. In such a case, the semi-cured state includes a state where the viscosity has started to increase but curing is not completed, and the like.

The prepreg to be obtained using the resin composition according to the present embodiment may include a semi-cured product of the resin composition as described above or include the uncured resin composition itself. In other words, the prepreg may be a prepreg including a semi-cured product of the resin composition (the resin composition in B stage) and a fibrous base material or a prepreg including the resin composition before being cured (the resin composition in A stage) and a fibrous base material. The resin composition or a semi-cured product of the resin composition may be one obtained by drying or heating and drying the resin composition.

When a prepreg is manufactured, the resin composition 2 is often prepared in a varnish form and used in order to be impregnated into the fibrous base material 3 which is a base material for forming the prepreg. In other words, the resin composition 2 is usually a resin varnish prepared in a varnish form in many cases. Such a varnish-like resin composition (resin varnish) is prepared, for example, as follows.

First, the respective components which can be dissolved in an organic solvent are introduced into and dissolved in an organic solvent. At this time, heating may be performed if necessary. Thereafter, components which are used if necessary but are not dissolved in the organic solvent are added to and dispersed in the solution until a predetermined dispersion state is achieved using a ball mill, a bead mill, a planetary mixer, a roll mill or the like, whereby a varnish-like resin composition is prepared. The organic solvent used here is not particularly limited as long as it dissolves the polyphenylene ether compound (A), the polyphenylene ether compound (B), the reactive compound (C) and the like and does not inhibit the curing reaction.

Specific examples thereof include toluene and methyl ethyl ketone (MEK).

Specific examples of the fibrous base material include glass cloth, aramid cloth, polyester cloth, a glass nonwoven fabric, an aramid nonwoven fabric, a polyester nonwoven fabric, pulp paper, and linter paper. When glass cloth is used, a laminated board exhibiting excellent mechanical strength is obtained, and glass cloth subjected to flattening is particularly preferable. Specific examples of the flattening include a method in which glass cloth is continuously pressed at an appropriate pressure using a press roll to flatly compress the yarn. The thickness of the generally used fibrous base material is, for example, 0.01 mm or more and 0.3 mm or less. The glass fiber constituting the glass cloth is not particularly limited, and examples thereof include Q glass, NE glass, E glass, S glass, T glass, L glass, and L2 glass. The surface of the fibrous base material may be subjected to a surface treatment with a silane coupling agent. The silane coupling agent is not particularly limited, and examples thereof include a silane coupling agent having at least one selected from the group consisting of a vinyl group, an acryloyl group, a methacryloyl group, a styryl group, an amino group, and an epoxy group in the molecule.

The method for manufacturing the prepreg is not particularly limited as long as the prepreg can be manufactured. Specifically, when the prepreg is manufactured, the resin composition according to the present embodiment described above is often prepared in a varnish form and used as a resin varnish as described above.

Specific examples of the method for manufacturing the prepreg 1 include a method in which the fibrous base material 3 is impregnated with the resin composition 2, for example, the resin composition 2 prepared in a varnish form, and then dried. The fibrous base material 3 is impregnated with the resin composition 2 by dipping, coating, and the like. If necessary, the impregnation can be repeated a plurality of times. Moreover, at this time, it is also possible to finally adjust the composition and impregnated amount to the desired composition and impregnated amount by repeating impregnation using a plurality of resin compositions having different compositions and concentrations.

The fibrous base material 3 impregnated with the resin composition (resin varnish) 2 is heated under desired heating conditions, for example, at 40° C. or more and 180° C. or less for 1 minute or more and 10 minutes or less. By heating, the prepreg 1 before being cured (A-stage) or in a semi-cured state (B-stage) is obtained. By the heating, the organic solvent can be decreased or removed by being volatilized from the resin varnish.

The resin composition according to the present embodiment is a resin composition affording a cured product, which is excellent in low dielectric properties, desmear properties, and adhesive properties to a metal foil and has a high glass transition temperature. For this reason, the prepreg including this resin composition or a semi-cured product of this resin composition is a prepreg affording a cured product, which is excellent in low dielectric properties, desmear properties, and adhesive properties to a metal foil and has a high glass transition temperature. Moreover, a wiring board including an insulating layer containing a cured product, which is excellent in low dielectric properties, desmear properties, and adhesive properties to a metal foil and has a high glass transition temperature, can be suitably manufactured using this prepreg.

### Metal-Clad Laminate

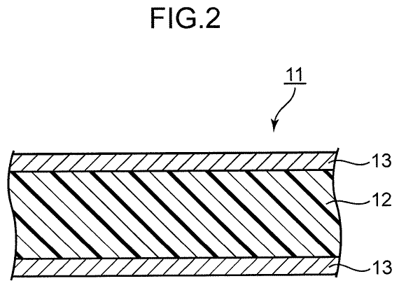

FIG. 2 is a schematic sectional view illustrating an example of a metal-clad laminate 11 according to an embodiment of the present invention.

As illustrated in FIG. 2, the metal-clad laminate 11 according to the present embodiment includes an insulating layer 12 containing a cured product of the resin composition and a metal foil 13 provided on the insulating layer 12. Examples of the metal-clad laminate 11 include a metal-clad laminate including an insulating layer 12 containing a cured product of the prepreg 1 illustrated in FIG. 1 and a metal foil 13 laminated on both or one of upper and lower surfaces of the insulating layer 12. The insulating layer 12 may be formed of a cured product of the resin composition or a cured product of the prepreg. In addition, the thickness of the metal foil 13 varies depending on the performance and the like to be required for the finally obtained wiring board and is not particularly limited. The thickness of the metal foil 13 can be appropriately set depending on the desired purpose and is preferably, for example, 0.2 to 70 μm. Examples of the metal foil 13 include a copper foil and an aluminum foil, and the metal foil 13 may be a copper foil with carrier which includes a release layer and a carrier for the improvement in handleability in a case where the metal foil is thin.

The method for manufacturing the metal-clad laminate 11 is not particularly limited as long as the metal-clad laminate 11 can be manufactured. Specific examples thereof include a method in which the metal-clad laminate 11 is fabricated using the prepreg 1. Examples of this method include a method in which the double-sided metal foil-clad or single-sided metal foil-clad laminate 11 is fabricated by stacking one sheet or a plurality of sheets of prepreg 1, further stacking the metal foil 13 such as a copper foil on both or one of upper and lower surfaces of the prepregs 1, and laminating and integrating the metal foils 13 and prepregs 1 by heating and pressing. In other words, the metal-clad laminate 11 is obtained by laminating the metal foil 13 on the prepreg 1 and then performing heating and pressing. The heating and pressing conditions can be appropriately set depending on the thickness of the metal-clad laminate 11, the kind of the resin composition contained in the prepreg 1, and the like. For example, it is possible to set the temperature to 170° C. to 230° C., the pressure to 2 to 4 MPa, and the time to 60 to 150 minutes. Moreover, the metal-clad laminate may be manufactured without using a prepreg. Examples thereof include a method in which a varnish-like resin composition is applied on a metal foil to form a layer containing the resin composition on the metal foil and then heating and pressing is performed.

The resin composition according to the present embodiment is a resin composition affording a cured product, which is excellent in low dielectric properties, desmear properties, and adhesive properties to a metal foil and has a high glass transition temperature. For this reason, the metal-clad laminate including an insulating layer containing a cured product of this resin composition is a metal-clad laminate including an insulating layer containing a cured product, which is excellent in low dielectric properties, desmear properties, and adhesive properties to a metal foil and has a high glass transition temperature.

The prepreg according to the present embodiment is a prepreg affording a cured product, which is excellent in low dielectric properties, desmear properties, and adhesive properties to a metal foil and has a high glass transition temperature. For this reason, the metal-clad laminate including an insulating layer containing a cured product of this prepreg is a metal-clad laminate including an insulating layer containing a cured product, which is excellent in low dielectric properties, desmear properties, and adhesive properties to a metal foil and has a high glass transition temperature.

Moreover, a wiring board including an insulating layer containing a cured product, which is excellent in low dielectric properties, desmear properties, and adhesive properties to a metal foil and has a high glass transition temperature, can be suitably manufactured using the metal-clad laminate.

### Wiring Board

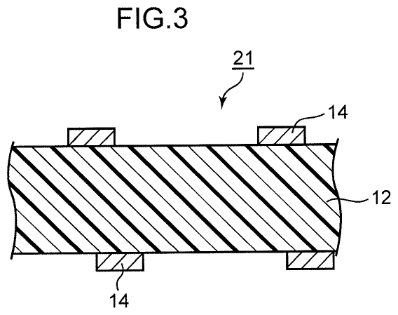

FIG. 3 is a schematic sectional view illustrating an example of a wiring board 21 according to an embodiment of the present invention.

As illustrated in FIG. 3, the wiring board 21 according to the present embodiment includes an insulating layer 12 containing a cured product of the resin composition and a wiring 14 provided on both or one of upper and lower surfaces of the insulating layer 12. Examples of the wiring board 21 include a wiring board including an insulating layer 12 obtained by curing the prepreg 1 illustrated in FIG. 1 and a wiring 14, which is laminated on both or one of upper and lower surfaces of the insulating layer 12 and is formed by partly removing the metal foil 13. The insulating layer 12 may be formed of a cured product of the resin composition or a cured product of the prepreg.

The method for manufacturing the wiring board 21 is not particularly limited as long as the wiring board 21 can be manufactured. Specific examples thereof include a method in which the wiring board 21 is fabricated using the prepreg 1. Examples of this method include a method in which the wiring board 21, in which wiring is provided as a circuit on the surface of the insulating layer 12, is fabricated by forming wiring through etching and the like of the metal foil 13 on the surface of the metal-clad laminate 11 fabricated in the manner described above. In other words, the wiring board 21 is obtained by partially removing the metal foil 13 on the surface of the metal-clad laminate 11 and thus forming a circuit. Examples of the method for forming a circuit include circuit formation by a semi-additive process (SAP) or a modified semi-additive process (MSAP) in addition to the method described above.

The wiring board 21 is a wiring board including an insulating layer 12 containing a cured product, which is excellent in low dielectric properties, desmear properties, and adhesive properties to a metal foil and has a high glass transition temperature.

### Metal Foil with Resin

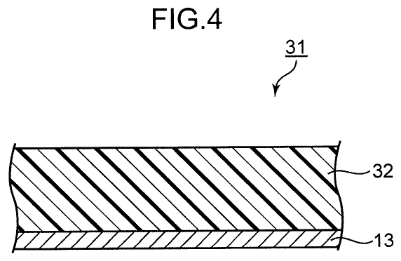

FIG. 4 is a schematic sectional view illustrating an example of a metal foil with resin 31 according to an embodiment of the present invention.

The metal foil with resin 31 according to the present embodiment includes a resin layer 32 containing the resin composition or a semi-cured product of the resin composition and a metal foil 13 as illustrated in FIG. 4. The metal foil with resin 31 includes the metal foil 13 on the surface of the resin layer 32. In other words, the metal foil with resin 31 includes the resin layer 32 and the metal foil 13 to be laminated together with the resin layer 32. The metal foil with resin 31 may include other layers between the resin layer 32 and the metal foil 13.

The resin layer 32 may contain a semi-cured product of the resin composition as described above or may contain the uncured resin composition. In other words, the metal foil with resin 31 may be a metal foil with resin including a resin layer containing a semi-cured product of the resin composition (the resin composition in B stage) and a metal foil or a metal foil with resin including a resin layer containing the resin composition before being cured (the resin composition in A stage) and a metal foil. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the metal foil, metal foils used in metal-clad laminates or metal foils with resin can be used without limitation. Examples of the metal foil include a copper foil and an aluminum foil.

The metal foil with resin 31 may include a cover film and the like if necessary. By including a cover film, it is possible to prevent entry of foreign matter and the like. The cover film is not particularly limited, and examples thereof include a polyolefin film, a polyester film, a polymethylpentene film, and films formed by providing a release agent layer on these films.

The method for manufacturing the metal foil with resin 31 is not particularly limited as long as the metal foil with resin 31 can be manufactured. Examples of the method for manufacturing the metal foil with resin 31 include a method in which the varnish-like resin composition (resin varnish) is applied on the metal foil 13 and heated to manufacture the metal foil with resin 31. The varnish-like resin composition is applied on the metal foil 13 using, for example, a bar coater. The applied resin composition is heated under the conditions of, for example, 40° C. or more and 180° C. or less and 0.1 minute or more and 10 minutes or less. The heated resin composition is formed as the uncured resin layer 32 on the metal foil 13. By the heating, the organic solvent can be decreased or removed by being volatilized from the resin varnish.

The resin composition according to the present embodiment is a resin composition affording a cured product, which is excellent in low dielectric properties, desmear properties, and adhesive properties to a metal foil and has a high glass transition temperature. For this reason, the metal foil with resin including a resin layer containing this resin composition or a semi-cured product of this resin composition is a metal foil with resin including a resin layer that affords a cured product, which is excellent in low dielectric properties, desmear properties, and adhesive properties to a metal foil and has a high glass transition temperature. Moreover, this metal foil with resin can be used when a wiring board is manufactured which includes an insulating layer containing a cured product, which is excellent in low dielectric properties, desmear properties, and adhesive properties to a metal foil and has a high glass transition temperature. For example, by laminating the metal foil with resin on a wiring board, a multilayer wiring board can be manufactured. As a wiring board obtained using such a metal foil with resin, there is obtained a wiring board including an insulating layer containing a cured product, which is excellent in low dielectric properties, desmear properties, and adhesive properties to a metal foil and has a high glass transition temperature.

### Film with Resin

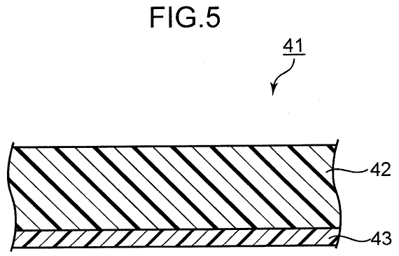

FIG. 5 is a schematic sectional view illustrating an example of a film with resin 41 according to an embodiment of the present invention.

The film with resin 41 according to the present embodiment includes a resin layer 42 containing the resin composition or a semi-cured product of the resin composition and a support film 43 as illustrated in FIG. 5. The film with resin 41 includes the resin layer 42 and the support film 43 to be laminated together with the resin layer 42. The film with resin 41 may include other layers between the resin layer 42 and the support film 43.

The resin layer 42 may contain a semi-cured product of the resin composition as described above or may contain the uncured resin composition. In other words, the film with resin 41 may be a film with resin including a resin layer containing a semi-cured product of the resin composition (the resin composition in B stage) and a support film or a film with resin including a resin layer containing the resin composition before being cured (the resin composition in A stage) and a support film. The resin layer is only required to contain the resin composition or a semi-cured product of the resin composition and may or may not contain a fibrous base material. The resin composition or a semi-cured product of the resin composition may be one obtained by drying or heating and drying the resin composition. As the fibrous base material, those similar to the fibrous base materials of the prepreg can be used.

As the support film 43, support films used in films with resin can be used without limitation. Examples of the support film include electrically insulating films such as a polyester film, a polyethylene terephthalate (PET) film, a polyimide film, a polyparabanic acid film, a polyether ether ketone film, a polyphenylene sulfide film, a polyamide film, a polycarbonate film, and a polyarylate film.

The film with resin 41 may include a cover film and the like if necessary. By including a cover film, it is possible to prevent entry of foreign matter and the like. The cover film is not particularly limited, and examples thercof include a polyolefin film, a polyester film, and a polymethylpentene film.

The support film and the cover film may be those subjected to surface treatments such as a matt treatment, a corona treatment, a release treatment, and a roughening treatment if necessary.

The method for manufacturing the film with resin 41 is not particularly limited as long as the film with resin 41 can be manufactured. Examples of the method for manufacturing the film with resin 41 include a method in which the varnish-like resin composition (resin varnish) is applied on the support film 43 and heated to manufacture the film with resin 41. The varnish-like resin composition is applied on the support film 43 using, for example, a bar coater. The applied resin composition is heated under the conditions of, for example, 40°° C. or more and 180° C. or less and 0.1 minute or more and 10 minutes or less. The heated resin composition is formed as the uncured resin layer 42 on the support film 43. By the heating, the organic solvent can be decreased or removed by being volatilized from the resin varnish.

The resin composition according to the present embodiment is a resin composition affording a cured product, which is excellent in low dielectric properties, desmear properties, and adhesive properties to a metal foil and has a high glass transition temperature. For this reason, the film with resin including a resin layer containing this resin composition or a semi-cured product of this resin composition is a film with resin including a resin layer that affords a cured product, which is excellent in low dielectric properties, desmear properties, and adhesive properties to a metal foil and has a high glass transition temperature. Moreover, this film with resin can be used when a wiring board is suitably manufactured which includes an insulating layer containing a cured product, which is excellent in low dielectric properties, desmear properties, and adhesive properties to a metal foil and has a high glass transition temperature. A multilayer wiring board can be manufactured, for example, by laminating the film with resin on a wiring board and then peeling off the support film from the film with resin or by peeling off the support film from the film with resin and then laminating the film with resin on a wiring board. As a wiring board obtained using such a film with resin, there is obtained a wiring board including an insulating layer containing a cured product, which is excellent in low dielectric properties, desmear properties, and adhesive properties to a metal foil and has a high glass transition temperature.

From the description above, according to the present invention, it is possible to provide a resin composition affording a cured product, which is excellent in low dielectric properties, desmear properties, and adhesive properties to a metal foil and has a high glass transition temperature. Furthermore, according to the present invention, it is possible to provide a prepreg, a film with resin, a metal foil with resin, a metal-clad laminate, and a wiring board, which are obtained using the resin composition.

This specification discloses techniques in various aspects as described above, and the main techniques among them are summarized below.

A resin composition according to a first aspect contains a polyphenylene ether compound (A) having a hydroxyl group in a molecule, a polyphenylene ether compound (B) having an unsaturated double bond in a molecule, a reactive compound (C) including at least one selected from a maleimide compound (C1) or a benzoxazine compound (C2), and an inorganic filler (D), in which a content of the polyphenylene ether compound (A) is 1 part by mass or more and less than 50 parts by mass with respect to 100 parts by mass of a sum of the polyphenylene ether compound (A) and the polyphenylene ether compound (B).

A resin composition according to a second aspect is the resin composition according to the first aspect, in which the reactive compound (C) includes at least one selected from the group consisting of a maleimide compound having a biphenylaralkyl structure, a maleimide compound having a phenylmaleimide group, a maleimide compound having an alkyl group having 6 or more carbon atoms, a maleimide compound having an alkylene group having 6 or more carbon atoms, and a maleimide compound having an alkyl group having 6 or more carbon atoms and an alkylene group having 6 or more carbon atoms.

A resin composition according to a third aspect is the resin composition according to the first or second aspect, in which the content of the polyphenylene ether compound (A) is 0.1 to 45 parts by mass with respect to 100 parts by mass of a sum of the polyphenylene ether compound (A), the polyphenylene ether compound (B), and the reactive compound (C).

A resin composition according to a fourth aspect is the resin composition according to any one of the first to third aspects, in which a content of the polyphenylene ether compound (B) is 10 to 70 parts by mass with respect to 100 parts by mass of a sum of the polyphenylene ether compound (A), the polyphenylene ether compound (B), and the reactive compound (C).

A resin composition according to a fifth aspect is the resin composition according to any one of the first to fourth aspects, in which a content of the reactive compound (C) is 10 to 80 parts by mass with respect to 100 parts by mass of a sum of the polyphenylene ether compound (A), the polyphenylene ether compound (B), and the reactive compound (C).

A resin composition according to a sixth aspect is the resin composition according to any one of the first to fifth aspects, in which the inorganic filler (D) is 10 to 250 parts by mass with respect to 100 parts by mass of a sum of the polyphenylene ether compound (A), the polyphenylene ether compound (B), and the reactive compound (C).

A resin composition according to a seventh aspect is the resin composition according to any one of the first to sixth aspects, in which the reactive compound (C) includes a maleimide compound (C1) and a benzoxazine compound (C2).

A resin composition according to an eighth aspect is the resin composition according to any one of the first to seventh aspects, the resin composition according to claim 1 in which the benzoxazine compound (C2) includes a benzoxazine compound (C2-1) having an alkenyl group.

A prepreg according to a ninth aspect includes the resin composition according to any one of the first to eighth aspects or a semi-cured product of the resin composition; and a fibrous base material.

A film with resin according to a tenth aspect includes a resin layer containing the resin composition according to any one of the first to eighth aspects or a semi-cured product of the resin composition; and a support film.

A metal foil with resin according to an eleventh aspect includes a resin layer containing the resin composition according to any one of the first to eighth aspects or a semi-cured product of the resin composition; and a metal foil.

A metal-clad laminate according to a twelfth aspect includes an insulating layer containing a cured product of the resin composition according to any one of the first to eighth aspects; and a metal foil.

A metal-clad laminate according to a thirteenth aspect includes an insulating layer containing a cured product of the prepreg according to the ninth aspect; and a metal foil.

A wiring board according to a fourteenth aspect includes an insulating layer containing a cured product of the resin composition according to any one of the first to eighth aspects; and a wiring.

A wiring board according to a fifteenth aspect includes an insulating layer containing a cured product of the prepreg according to the ninth aspect; and a wiring.

Hereinafter, the present invention will be described more specifically with reference to examples, but the scope of the present invention is not limited thereto.

### EXAMPLE

### Examples 1 to 12 and Comparative Examples 1 to 6

First, the respective components used when a prepreg is fabricated in the present Examples will be described.

### (Polyphenylene Ether Compound (A))

PPE: Polyphenylene ether compound having hydroxyl group in molecule (SA90 manufactured by SABIC Innovative Plastics Co., Ltd., number of terminal hydroxyl groups: 2, number average molecular weight Mn: 1700, phenol equivalent (hydroxyl group equivalent): 850 g/eq)

### (Polyphenylene Ether Compound (B))

Modified PPE: Polyphenylene ether compound having vinylbenzyl group (ethenylbenzyl group) at molecular terminal (styrene-modified polyphenylene ether) (OPE-1200 manufactured by Mitsubishi Gas Chemical Company, Inc., number average molecular weight Mn: 1200, functional group equivalent of vinylbenzyl group: 670 g/eq)

### (Reactive Compound (C))

Maleimide compound 1: Biphenylaralkyl-type bismaleimide compound (MIR-3000-70MT manufactured by Nippon Kayaku Co., Ltd., bismaleimide compound, functional group equivalent of maleimide group: 275 g/eq)

Maleimide compound 2:3,3′-Dimethyl-5,5′-diethyl-4,4′-diphenylmethanebismaleimide (BMI-5100 manufactured by Nippon Kayaku Co., Ltd., bismaleimide compound, functional group equivalent of maleimide group: 221 g/eq)

Maleimide compound 3: Maleimide compound having alkyl group having 6 or more carbon atoms and alkylene group having 6 or more carbon atoms (BMI-689 manufactured by Designer Molercules Inc.)

Benzoxazine compound 1: 3,3′-(Methylene-1,4-diphenylene) bis (3,4-dihydro-2H-1,3-benzoxazine) (P-d type benzoxazine compound manufactured by SHIKOKU CHEMICALS CORPORATION, functional group equivalent of benzoxazine group: 217 g/eq)

Benzoxazine compound 2: Benzoxazine compound having allyl group that is alkenyl group in molecule (benzoxazine compound represented by Formula (14), where X is methylene group, R₄₅ and R₄₆ are allyl group, and q and r are 1 (ALP-d type benzoxazine compound manufactured by SHIKOKU CHEMICALS CORPORATION, functional group equivalent of benzoxazine group: 244 g/eq))

### (Inorganic Filler (D))

SC2300-SVJ: Spherical silica subjected to surface treatment with vinylsilane (SC2300-SVJ manufactured by ADMATECHS COMPANY LIMITED)

### (Curing Accelerator)

2E4MZ: Imidazole-based curing accelerator (2-ethyl-4-methylimidazole, 2E4MZ manufactured by SHIKOKU CHEMICALS CORPORATION)

### (Preparation Method)

The components other than the inorganic filler were added to methyl ethyl ketone (MEK) at the compositions (parts by mass) presented in Table 1 so that the solid concentration was 60% by mass, and the mixture was stirred and mixed using a disperser for homogenization. The inorganic filler was added to the homogenized mixture at the composition (parts by mass) presented in Table 1, and the mixture was stirred and mixed using a disperser for 2 hours for homogenization. By doing so, a varnish-like resin composition (varnish) was obtained.

Next, a prepreg and an evaluation substrate 1 (metal-clad laminate) were obtained as follows.

The obtained varnish was impregnated into a fibrous base material (glass cloth: “2116 type cloth” manufactured by Nitto Boseki Co., Ltd.) and then heated and dried at 150° C. using a non-contact type heating unit. By doing so, the solvent in the varnish was removed and the resin composition was semi-cured to obtain a prepreg (340 mm×510 mm). At that time, the content (resin content) of the components constituting the resin composition with respect to the prepreg was adjusted to be 47% by mass by the curing reaction.

Next, an evaluation substrate 1 (metal-clad laminate) was obtained as follows.

Six sheets of each of the obtained prepregs were stacked, and copper foil (manufactured by Mitsui Mining & Smelting Co., Ltd., thickness: 35 μm, ST foil, one roughened surface) was disposed on both sides of the stacked body so that the roughened surface was on the prepreg side. This as a body to be pressed was heated and pressed under the conditions of 200° C., 90 minutes, and a pressure of 2.94 MPa, thereby obtaining a copper-clad laminate (evaluation substrate 1: metal-clad laminate) having a copper foil bonded to both surfaces and a thickness of about 0.6 mm.

A copper-clad laminate (evaluation substrate 2: metal-clad laminate) having a copper foil bonded to both surfaces and a thickness of about 0.8 mm was obtained in the same manner as the evaluation substrate 1 except that the number of sheets of prepreg used was changed to 8.

A copper-clad laminate (evaluation substrate 3: metal-clad laminate) having a copper foil bonded to both surfaces and a thickness of about 0.1 mm was obtained in the same manner as the evaluation substrate 1 except that the number of sheets of prepreg used was changed to 1.

The evaluation substrates 1 to 3 (copper-clad laminates) fabricated as described above were subjected to the evaluation by the following methods.

### Desmear Properties

First, the copper foil on the surface of the evaluation substrate 1 (copper-clad laminate) was removed by etching. As a desmear process, the substrate from which the copper foil was removed was immersed in a swelling liquid (Swelling Dip Securiganth P manufactured by Atotech) at 60° C. for 5 minutes, then immersed in an aqueous potassium permanganate solution (Concentrate Compact CP manufactured by Atotech) at 80° C. for 10 minutes, and then subjected to neutralization. Before and after such a desmear process, the weight of the substrate was measured, and the amount of weight decrease (weight of substrate before desmear process-weight of substrate after desmear process) due to the desmear process was calculated, and the amount of weight decrease per 1 mm² (mg/mm²) was calculated from the amount of weight decrease. Based on the amount of weight decrease per 1 mm², evaluation was performed as follows.

It was evaluated as “A (poor)” when the amount of weight decrease per 1 mm² was less than 15 mg/mm², it was evaluated as “B (good)” when the amount of weight decrease per 1 mm² was 15 mg/mm² or more and less than 30 mg/mm², it was evaluated as “C (excellent)” when the amount of weight decrease per 1 mm² was 30 mg/mm² or more and less than 45 mg/mm², and it was evaluated as “D (poor)” when the amount of weight decrease per 1 mm² was 45 mg/mm² or more.

The “A (poor)” is not preferable since it is difficult to remove desmear, and the “D (poor)” is not preferable since the resin is excessively removed and the shape of the vias and the like cannot be maintained. On the other hand, “B (good)” and “C (excellent)” are preferable since desmear can be removed while the shape of vias and the like can be maintained, and “C (excellent)” is more preferable from this point.

### Relative Dielectric Constant (Dk)

The relative dielectric constant (Dk) at 1 GHz was measured by the cavity perturbation method using an unclad substrate obtained by removing the copper foil from the evaluation substrate 2 (copper-clad laminate) by etching as a test piece. Specifically, the relative dielectric constant (Dk) of the unclad substrate (insulating layer included in the evaluation substrate 2) was measured at 1 GHz in conformity with IPC-TM-650 2.5.5.9 using “Impedance/Material Analyzer 4291A” manufactured by Hewlett-Packard Company. A relative dielectric constant of 3.4 or less is favorable.

### Glass Transition Temperature (Tg)

Using an unclad substrate obtained by removing the copper foil from the evaluation substrate 2 (copper-clad laminate) by etching as a test piece, the glass transition temperature (Tg) of the unclad substrate (the insulating layer included in the evaluation substrate 2) was measured using a viscoelastic spectrometer “DMS6100” manufactured by Seiko Instruments Inc. At this time, dynamic viscoelasticity measurement (DMA) was performed with a tensile module at a frequency of 10 Hz, and the temperature at which tan & was maximized when the temperature was raised from room temperature to 280° C. at a rate of temperature rise of 5° C./min was taken as the glass transition temperature Tg (°° C.). A glass transition temperature of 240° C. or more is favorable.

### Peel Strength

The copper foil was peeled off from the evaluation substrate 3, and the peel strength at that time was measured in conformity with JIS C6481. Specifically, the copper foil was peeled off from the evaluation substrate 3 at a speed of 50 mm/min using a tensile tester, and the peel strength (N/mm) at that time was measured.

The results of the evaluation are presented in Table 1.

TABLE 1

| | | | | Example | | | | | | |
|---|---|---|---|---|---|---|---|---|---|---|
| | | | | 1 | 2 | 3 | 4 | 5 | 6 | 7 |
| Composition | Polyphenylene | | PPE | 5 | 10 | 15 | 15 | 20 | 10 | 30 |
| (parts | ether compound (A) | | | | | | | | | |
| by mass) | Polyphenylene | | Modified PPE | 45 | 40 | 35 | 35 | 30 | 20 | 40 |
| | ether compound (B) | | | | | | | | | |
| | Reactive | Maleimide | Maleimide | 20 | 20 | 20 | 20 | 20 | 30 | 10 |
| | compound | Compound | compound 1 | | | | | | | |
| | (C) | (C1) | Maleimide | 20 | 20 | 20 | 20 | 20 | 30 | 10 |
| | | | compound 2 | | | | | | | |
| | | | Maleimide | 0 | 0 | 0 | 0 | 0 | 0 | 0 |
| | | | compound 3 | | | | | | | |
| | | Benzoxazine | Benzoxazine | 10 | 10 | 10 | 0 | 10 | 10 | 10 |
| | | Compound | compound 1 | | | | | | | |
| | | (C2) | Benzoxazine | 0 | 0 | 0 | 10 | 0 | 0 | 0 |
| | | | compound 2 | | | | | | | |

| | | | | | | | | |
|---|---|---|---|---|---|---|---|---|
| Inorganic filler (D) | SC2300-SVJ | 100 | 100 | 100 | 100 | 100 | 100 | 100 |
| Curing accelerator | 2E4MZ | 0.3 | 0.3 | 0.3 | 0.3 | 0.3 | 0.3 | 0.3 |

| Evaluation | Desmear properties | B | C | C | C | C | C | C |
|---|---|---|---|---|---|---|---|---|
| | | (good) | (excel- | (excel- | (excel- | (excel- | (excel- | (excel- |
| | | | lent) | lent) | lent) | lent) | lent) | lent) |
| | Relative dielectric constant Dk | 3.2 | 3.3 | 3.3 | 3.3 | 3.3 | 3.3 | 3.2 |
| | Glass transition temperature Tg | 260 | 256 | 255 | 260 | 252 | 265 | 254 |
| | (° C) | | | | | | | |
| | Peel strength (N/mm) | 0.66 | 0.64 | 0.62 | 0.66 | 0.60 | 0.61 | 0.57 |

| | | | | | | | | | Comparative |
|---|---|---|---|---|---|---|---|---|---|
| | | | | Example | | | | | Example |
| | | | | 8 | 9 | 10 | 11 | 12 | 1 |
| Composition | Polyphenylene | | PPE | 20 | 20 | 20 | 20 | 20 | 0 |
| (parts | ether compound (A) | | | | | | | | |
| by mass) | Polyphenylene | | Modified PPE | 30 | 30 | 30 | 30 | 30 | 50 |
| | ether compound (B) | | | | | | | | |
| | Reactive | Maleimide | Maleimide | 25 | 50 | 0 | 0 | 45 | 20 |
| | compound | Compound | compound 1 | | | | | | |
| | (C) | (C1) | Maleimide | 25 | 0 | 50 | 0 | 0 | 20 |
| | | | compound 2 | | | | | | |
| | | | Maleimide | 0 | 0 | 0 | 0 | 5 | 0 |
| | | | compound 3 | | | | | | |
| | | Benzoxazine | Benzoxazine | 0 | 0 | 0 | 50 | 0 | 10 |
| | | Compound | compound 1 | | | | | | |
| | | (C2) | Benzoxazine | 0 | 0 | 0 | 0 | 0 | 0 |
| | | | compound 2 | | | | | | |

| | | | | | | | |
|---|---|---|---|---|---|---|---|
| Inorganic filler (D) | SC2300-SVJ | 100 | 100 | 100 | 100 | 100 | 100 |
| Curing accelerator | 2E4MZ | 0.3 | 0.3 | 0.3 | 0.3 | 0.3 | 0.3 |

| Evaluation | Desmear properties | C | C | C | C | C | A |
|---|---|---|---|---|---|---|---|
| | | (excel- | (excel- | (excel- | (excel- | (excel- | (poor) |
| | | lent) | lent) | lent) | lent) | lent) | |
| | Relative dielectric constant Dk | 3.2 | 3.3 | 3.2 | 3.3 | 3.1 | 3.1 |
| | Glass transition temperature Tg | 258 | 258 | 252 | 259 | 250 | 261 |
| | (° C) | | | | | | |
| | Peel strength (N/mm) | 0.61 | 0.61 | 0.56 | 0.60 | 0.64 | 0.68 |

| | | | Comparative | | | | |
|---|---|---|---|---|---|---|---|
| | | | Example | | | | |
| | | | 2 | 3 | 4 | 5 | 6 |
| Composition | Polyphenylene | PPE | 50 | 40 | 30 | 20 | 40 |
| (parts | ether compound (A) | | | | | | |
| by mass) | Polyphenylene | Modified PPE | 0 | 60 | 20 | 10 | 30 |
| | ether compound (B) | | | | | | |

| | | | | | | | |
|---|---|---|---|---|---|---|---|
| Reactive | Maleimide | Maleimide | 20 | 0 | 20 | 30 | 10 |
| compound | Compound | compound 1 | | | | | |
| (C) | (C1) | Maleimide | 20 | 0 | 20 | 30 | 10 |
| | | compound 2 | | | | | |
| | | Maleimide | 0 | 0 | 0 | 0 | 0 |
| | | compound 3 | | | | | |
| | Benzoxazine | Benzoxazine | 10 | 0 | 10 | 10 | 10 |
| | Compound | compound 1 | | | | | |
| | (C2) | Benzoxazine | 0 | 0 | 0 | 0 | 0 |
| | | compound 2 | | | | | |

| | | | | | | |
|---|---|---|---|---|---|---|
| Inorganic filler (D) | SC2300-SVJ | 100 | 100 | 100 | 100 | 100 |
| Curing accelerator | 2E4MZ | 0.3 | 0.3 | 0.3 | 0.3 | 0.3 |

| | | | | | | |
|---|---|---|---|---|---|---|
| Evaluation | Desmear properties | D | C | D | D | D |

| | (poor) | (excellent) | (poor) | (poor) | (poor) |
|---|---|---|---|---|---|
| Relative dielectric constant Dk | 3.4 | 3.3 | 3.3 | 3.3 | 3.3 |
| Glass transition temperature Tg | 247 | 201 | 247 | 238 | 235 |
| (° C) | | | | | |
| Peel strength (N/mm) | 0.41 | 0.55 | 0.51 | 0.53 | 0.48 |

From Table 1, it can be seen that a cured product, which is excellent in low dielectric properties, desmear properties, and peel strength, and has a high glass transition temperature, is obtained in the case of a resin composition containing a polyphenylene ether compound (A) having a hydroxyl group in the molecule, a polyphenylene ether compound (B) having an unsaturated double bond in the molecule, a reactive compound (C) including at least one selected from a maleimide compound (C1) or a benzoxazine compound (C2), and an inorganic filler (D), in which the content of the polyphenylene ether compound (A) is 1 part by mass or more and less than 50 parts by mass with respect to 100 parts by mass of the sum of the polyphenylene ether compound (A) and the polyphenylene ether compound (B) (Examples 1 to 12).

In contrast, it can be seen that the desmear properties are inferior in a case where the polyphenylene ether compound (A) is not contained (Comparative Example 1). It can be seen that the peel strength is low and the desmear properties are inferior in a case where the polyphenylene ether compound (B) is not contained (Comparative Example 2). Furthermore, it can be seen that the glass transition temperature is low in a case where the reactive compound (C) is not contained (Comparative Example 3).

It can be seen that the desmear properties are inferior in a case where the polyphenylene ether compound (A) and the polyphenylene ether compound (B) are contained but the content of the polyphenylene ether compound (A) is 50 parts by mass or more with respect to 100 parts by mass of the sum of the polyphenylene ether compound (A) and the polyphenylene ether compound (B) (Comparative Examples 4 to 6).

From the comparison of Comparative Examples 1 and 2 and Comparative Examples 4 to 6 with Examples 1 to 12 (particularly Examples 1 to 3 and Example 5) described above, it can be seen that the content of the polyphenylene ether compound (A) is required to be 1 part by mass or more and less than 50 parts by mass with respect to 100 parts by mass of the sum of the polyphenylene ether compound (A) and the polyphenylene ether compound (B).

From the comparison of Example 3 with Example 4, it can be seen that a cured product having a superior peel strength and a higher glass transition temperature is obtained in a case where a benzoxazine compound (C2-1) having an alkenyl group is contained as the benzoxazine (C2) (Example 4).

When Examples 8 to 10 and 12 are compared with one another, it can be seen that a cured product excellent in relative dielectric constant, peel strength, and glass transition temperature in a well-balanced manner is obtained in a case where the reactive compound (C) includes the maleimide compound (C1-1) and a maleimide compound (C1-2) other than the maleimide compound (C1-1) as the maleimide compound (C1) (Examples 8 and 12).

This application is based on Japanese Patent Application No. 2022-115729 filed on Jul. 20, 2022, and the contents of which are included in the present application.

In order to express the present invention, the present invention has been described above appropriately and sufficiently through the embodiments with reference to specific examples, drawings and the like. However, it should be recognized by those skilled in the art that changes and/or improvements of the above-described embodiments can be readily made. Accordingly, changes or improvements made by those skilled in the art shall be construed as being included in the scope of the claims unless otherwise the changes or improvements are at the level which departs from the scope of the appended claims.

### INDUSTRIAL APPLICABILITY

The present invention has a wide range of industrial applicability in the technical field relating to electronic materials and various devices using the same.

1. A resin composition comprising:
a polyphenylene ether compound (A) having a hydroxyl group in a molecule;
a polyphenylene ether compound (B) having an unsaturated double bond in a molecule;
a reactive compound (C) including at least one selected from a maleimide compound (C1) or a benzoxazine compound (C2); and
an inorganic filler (D), wherein
a content of the polyphenylene ether compound (A) is 1 part by mass or more and less than 50 parts by mass with respect to 100 parts by mass of a sum of the polyphenylene ether compound (A) and the polyphenylene ether compound (B).

2. The resin composition according to claim 1, wherein the reactive compound (C) includes at least one selected from the group consisting of a maleimide compound having a biphenylaralkyl structure, a maleimide compound having a phenylmaleimide group, a maleimide compound having an alkyl group having 6 or more carbon atoms, a maleimide compound having an alkylene group having 6 or more carbon atoms, and a maleimide compound having an alkyl group having 6 or more carbon atoms and an alkylene group having 6 or more carbon atoms.

3. The resin composition according to claim 1, wherein the content of the polyphenylene ether compound (A) is 0.1 to 45 parts by mass with respect to 100 parts by mass of a sum of the polyphenylene ether compound (A), the polyphenylene ether compound (B), and the reactive compound (C).

4. The resin composition according to claim 1, wherein a content of the polyphenylene ether compound (B) is 10 to 70 parts by mass with respect to 100 parts by mass of a sum of the polyphenylene ether compound (A), the polyphenylene ether compound (B), and the reactive compound (C).

5. The resin composition according to claim 1, wherein a content of the reactive compound (C) is 10 to 80 parts by mass with respect to 100 parts by mass of a sum of the polyphenylene ether compound (A), the polyphenylene ether compound (B), and the reactive compound (C).

6. The resin composition according to claim 1, wherein a content of the inorganic filler (D) is 10 to 250 parts by mass with respect to 100 parts by mass of a sum of the polyphenylene ether compound (A), the polyphenylene ether compound (B), and the reactive compound (C).

7. The resin composition according to claim 1, wherein the reactive compound (C) includes a maleimide compound (C1) and a benzoxazine compound (C2).

8. The resin composition according to claim 1, wherein the benzoxazine compound (C2) includes a benzoxazine compound (C2-1) having an alkenyl group.

9. A prepreg comprising:
the resin composition according to claim 1 or a semi-cured product of the resin composition; and
a fibrous base material.

10. A film with resin comprising:
a resin layer containing the resin composition according claim 1 or a semi-cured product of the resin composition; and
a support film.

11. A metal foil with resin comprising:
a resin layer containing the resin composition according to claim 1 or a semi-cured product of the resin composition; and
a metal foil.

12. A metal-clad laminate comprising:
an insulating layer containing a cured product of the resin composition according to claim 1; and
a metal foil.

13. A metal-clad laminate comprising:
an insulating layer containing a cured product of the prepreg according to claim 9; and
a metal foil.

14. A wiring board comprising:
an insulating layer containing a cured product of the resin composition according to claim 1; and
a wiring.

15. A wiring board comprising:
an insulating layer containing a cured product of the prepreg according to claim 9; and
a wiring.
